(19) United States
(12) Patent Application Publication
(10) Pub. No.: US 2026/0236669 A1
(43) Pub. Date: Aug. 13, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: SATORU TAKAHASHI, Tokyo (JP)

(21) Appl. No.: 19/537,039

(22) Filed: Feb. 11, 2026

(30) Foreign Application Priority Data
Feb. 12, 2025 (JP) 2025-020848

(51) Int. Cl. G06F 40/166; G06F 40/289; G06F 40/40; G06T 11/60; G06V 30/10

(52) U.S. Cl. CPC G06F 40/166; G06F 40/289; G06F 40/40; G06T 11/60; G06V 30/10

(57) ABSTRACT

An information processing apparatus includes an accepting unit to accept a designation of first contents before replacement from among contents included in layout data, and a designation of second contents to be arranged in the layout data instead of the first contents, a specifying unit to specify third contents related to the first contents among the contents, an obtaining unit to obtain fourth contents related to the second contents, and a replacement unit to replace the first contents with the second contents and the third contents with the fourth contents in the layout data, wherein the specifying unit extracts a word or phrase indicating features of the first contents as a first keyword, extracts, as a contents keyword, a word or phrase indicating features of each of the contents, and specifies, among the contents, contents having the contents keyword related to the first keyword as the third contents.

### BACKGROUND

### Field of the Technology

The present disclosure relates to an information processing apparatus, an information processing method, and a storage medium.

### Description of the Related Art

Editing applications for creating data for products such as posters and advertisements (hereinafter referred to as layout data) are widespread.

By the way, Japanese Patent Laid-Open No. 2020-135129 (Patent Literature 1) has disclosed a technology related to automatic arrangement of contents in the layout data using an editing application. Patent Literature 1 describes a technique in which, in a case where a user has arranged a desired image in an image slot of a template, texts and stamp images determined by additional information of the image are automatically arranged in a specific contents slot associated with the image slot. For example, in a case where the image arranged in the image slot by the user was taken in January, the text "January" is arranged in a particular contents slot associated with the image slot.

However, in the technique of Patent Literature 1, there is no description about an unspecified contents slot that is not associated with the image slot.

### SUMMARY

An information processing apparatus of the present disclosure comprises one or more processors; and one or more memories storing instructions to cause the one or more processors to function as: an accepting unit configured to accept a designation of first contents before replacement from among a plurality of contents included in layout data, and a designation of second contents to be arranged in the layout data instead of the first contents, a specifying unit configured to specify, from among the plurality of contents included in the layout data, third contents related to the first contents, an obtaining unit configured to obtain fourth contents related to the second contents, and a replacement unit configured to replace the first contents with the second contents and the third contents with the fourth contents in the layout data, wherein the specifying unit extracts a word or phrase indicating features of the first contents as a first keyword, extracts, as a contents keyword, for each of the plurality of contents other than the first contents, a word or phrase indicating features of the each of the plurality of contents other than the first contents, and specifies, from among the plurality of contents other than the first contents, contents having the contents keyword related to the first keyword as the third contents.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the system configuration of an information processing system;

FIG. 2 is a diagram illustrating the hardware configuration of a server;

FIG. 3 is a diagram illustrating the hardware configuration of a client terminal;

FIGS. 4A and 4B are diagrams illustrating the software configuration of the information processing system;

FIG. 5 is a diagram illustrating the functional configuration of a contents replacement processing unit;

FIGS. 6A to 6D are diagrams for describing the processing of extracting keywords from image contents;

FIGS. 7A to 7D are diagrams for describing the processing of extracting keywords from text contents;

FIG. 8 is a diagram illustrating an example of a user interface (UI) screen of a layout editing application;

FIG. 9 is a diagram illustrating an example of layout data to be processed;

FIG. 10 is a diagram illustrating an example of a data table corresponding to the layout data illustrated in FIG. 9;

FIG. 11 is a diagram showing the relationship between FIGS. 11A and 11B;

FIGS. 11A and 11B are flowcharts illustrating the flow of contents replacement processing according to a first embodiment;

FIGS. 12A to 12C are diagrams illustrating replacement of first image contents with second image contents;

FIG. 13 is a flowchart illustrating the flow of obtaining processing A of fourth contents;

FIGS. 14A to 14C are diagrams illustrating examples of replacement of text contents;

FIG. 15 is a flowchart illustrating the flow of obtaining processing B of the fourth contents;

FIG. 16 is a diagram illustrating examples of prompts and answers for obtaining the fourth contents;

FIG. 17 is a diagram illustrating an example of a data table after replacement;

FIG. 18 is a diagram illustrating an example of layout data after replacement;

FIG. 19 is a flowchart illustrating a modification of the obtaining processing B of the fourth contents;

FIG. 20 is a diagram illustrating a selection UI for the fourth contents;

FIG. 21 is a diagram illustrating the functional configuration of a contents replacement processing unit in a second embodiment;

FIG. 22 is a diagram illustrating an example of layout data to be processed according to the second embodiment;

FIG. 23 is a diagram illustrating an example of a data table corresponding to the layout data illustrated in FIG. 22;

FIG. 24 is a diagram showing the relationship between FIGS. 24A and 24B;

FIGS. 24A and 24B are flowcharts illustrating the flow of contents replacement processing according to the second embodiment;

FIGS. 25A and 25B are diagrams for describing contents generation processing;

FIG. 26 is a diagram illustrating an example of a data table after replacement;

FIG. 27 is a diagram illustrating an example of layout data after replacement; and

FIGS. 28A to 28D are diagrams illustrating examples of contents replacement in Modification 3.

### DESCRIPTION OF THE EMBODIMENTS

Hereinafter, embodiments of the present disclosure will be described in detail with reference to the accompanying drawings. It should be noted that the following embodiments do not limit the scope of the claims, and not all of the combinations of features described in the embodiments are necessarily essential to the solutions of the present disclosure.

In each of the following embodiments, a description will be given of an information processing apparatus that functions as a layout editing apparatus for creating and editing data for a product such as a poster, and an information processing method. Here, as a procedure for creating layout data using the above-described editing application, there are cases where a template similar to a completed image or layout data created in the past is selected, and images and texts in this layout data are replaced with other images and texts. For example, a case is considered where new layout data for a summer image is created based on layout data for a winter image including an image of a "snow scene" and the text "January." In this case, the user changes the image of the "snow scene" to, for example, an image of a "summer festival." With this change in image, the text "January" in the layout data also needs to be replaced with contents that are consistent with the image of the "summer festival," such as "August." Normally, such contents replacement work in layout data is manually performed by the user, which takes time and effort. An object of the present disclosure is to improve the usability in editing work of layout data.

In the present specification, data for editing a product such as a poster to be processed by a layout editing apparatus is referred to as layout data. The layout data is data in which one or more objects are arranged on an image plane having a predetermined size, and is, for example, data in HTML format, but may be image data or text data. In the embodiments, objects included in the layout data are referred to as contents. Objects that are image data are referred to as image contents, and objects that are text data are referred to as text contents. The layout data includes other additional information such as the data, type, position, size, and the like of contents. The layout data to be processed by the layout editing apparatus may be template data created in advance, or may be layout data created and edited by the user. In addition, the layout data may be layout data automatically generated by a generative AI. The details of layout data and contents will be described later.

The layout data of a product created by using the layout editing apparatus is converted into an image by rendering processing. This image data is referred to as the layout image in the present specification. The layout image can be utilized not only by being printed, but also as electronic contents on websites, social networking services SNSs , virtual spaces, and the like. Products include posters, brochures, menus, postcards, leaflets (flyers), banners, business cards, shop cards, invitations, membership cards, and the like.

### First Embodiment

### System Configuration

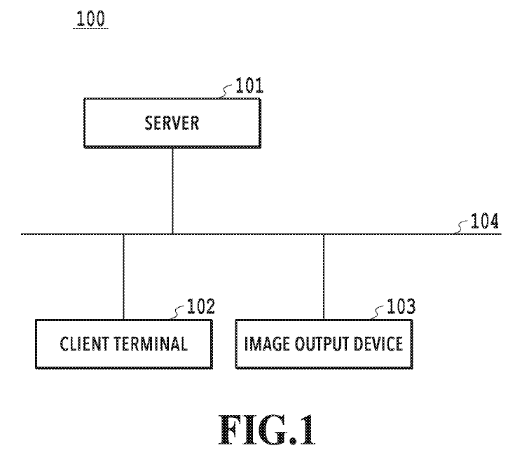

FIG. 1 is a diagram illustrating an example of the configuration of an information processing system 100 according to the present embodiment. As illustrated in FIG. 1, the information processing system 100 according to the present embodiment includes a server 101 that provides a layout editing service, and a client terminal 102 that cooperates with the server 101 to perform an editing operation of layout data. In addition, the information processing system 100 may be configured to include an image output device 103 that outputs layout images. In the present embodiment, the image output device 103 is a printer that prints out layout images but may be a multifunction peripheral (MFP) or the like. The server 101, the client terminal 102, and the image output device 103 are communicatively connected to each other via a network 104. Although FIG. 1 illustrates the system configuration in which one server 101, one client terminal 102, and one image output device 103 are connected, the system configuration is not limited to this, and a plurality of these may be connected. The information processing system 100 has an editing function, a printing function, and a communication function of layout data.

Each device constituting the information processing system 100 establishes its communication via the network 104 connecting the devices, enabling transmission and reception of data. The network 104 includes a communication network such as a LAN or the Internet, a short-range communication network such as Bluetooth (R), and other communication networks, and may be a wired network or a wireless network.

In the information processing system 100, the server 101 executes editing processing of layout data while accepting an operation instruction by the user received from the client terminal 102. In addition, the server 101 transmits the processing result to the client terminal 102 and causes the processing result to be displayed so that the user can visually confirm the processing result. The client terminal 102 is equipped with a web browser and displays the display data of a UI (user interface) screen transmitted from the server 101 on a display unit of the client terminal 102. The client terminal 102 accepts various instructions by the user for the layout data via the UI screen and transmits the accepted instruction data to the server 101. In addition, the client terminal 102 receives data of the processing result transmitted from the server 101 and reflects the data to the layout data displayed on the UI screen. The details of the editing processing of the layout data and the UI screen will be described later.

The server 101 or the client terminal 102 has an application program (hereinafter referred to as the layout editing application) for realizing the editing function of layout data. The layout editing application may be a web application that runs on the browser of the client terminal 102 while cooperating with the server 101 via the web, or a native application in which the client terminal 102 mainly performs editing processing, and the application may take any form. The client terminal 102 may request the server 101 to perform a part or all of the editing processing and obtain data of the processing result from the server 101. The layout editing application will be described later.

The client terminal 102 generates a print job by adding print setting data to image data obtained by converting the layout data generated by the editing processing into a layout image and transmits the print job to the image output device 103. The processing of converting the layout data into the layout image may be performed by the server 101 or may be performed by the client terminal 102. The image output device 103 executes printing processing based on the print job. For example, a printing application program (hereinafter referred to as the printing application) and a printer driver are installed on the client terminal 102. The printing application and the printer driver will be described later.

The image output device 103 executes printing of a print image (layout image) of the layout data generated by the layout editing application based on the print setting of the print job received from the client terminal 102. The image output device 103 holds, as device information, information about ink empty, configuration information about paper, and status information indicating an idle state, a print error state, and the like. Furthermore, in a case where the image output device 103 cannot normally execute printing due to a problem with the image output device 103, such as a lack of paper or ink being empty, or an error in the print setting, the image output device 103 displays a warning message on a main panel of the image output device 103. In this manner, the reason why printing cannot be normally performed is presented to the user.

### Hardware Configuration

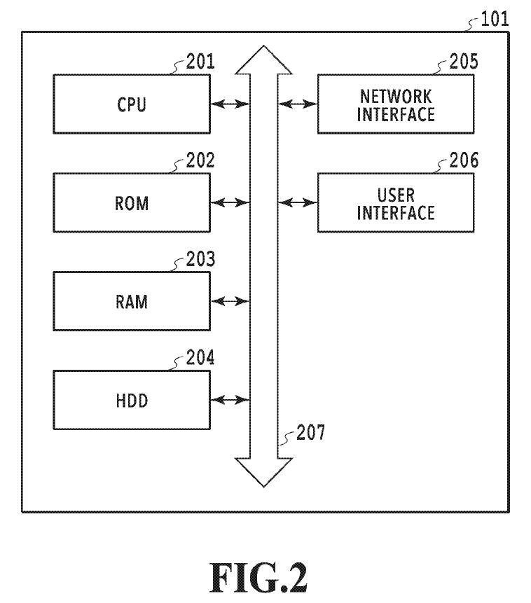

FIG. 2 is a diagram illustrating an example of the hardware configuration of an information processing apparatus that functions as the server 101. The server 101 includes a CPU 201, a ROM 202, a RAM 203, an HDD 204, a network interface 205, a user interface 206, and the like. Each of these units is connected via a bus 207. The CPU 201 reads various programs, such as a control program, a system program, and an application program, from the ROM 202 or the HDD 204 into the RAM 203. The CPU 201 executes various programs read into the RAM 203 to execute various kinds of data processing. The CPU 201 may be a dedicated circuit such as an ASIC. The CPU 201 and the dedicated circuit are examples of a hardware circuit or a hardware processor. The ROM 202 is a non-volatile memory that stores an operating system, pre-installed programs, and data. The RAM 203 is a volatile memory that provides a temporary memory area. The HDD 204 is a large-capacity storage device. The HDD 204 may be a flash memory, an SSD, or an external storage connected via the network interface 205. The user interface 206 is an operation display unit that includes a display, a keyboard, a mouse, buttons, a touch panel, and the like, and performs input and output of information and signals. The network interface 205 is connected to the network 104 to perform communication with the client terminal 102, the image output device 103, other computers, and network devices. The HDD 204 of the server 101 stores various application programs such as a server program for the layout editing application, a print image generation program, and a backend application for the layout editing application. In addition, the HDD 204 stores a layout data DB 412 and data required for various kinds of processing executed by the server 101.

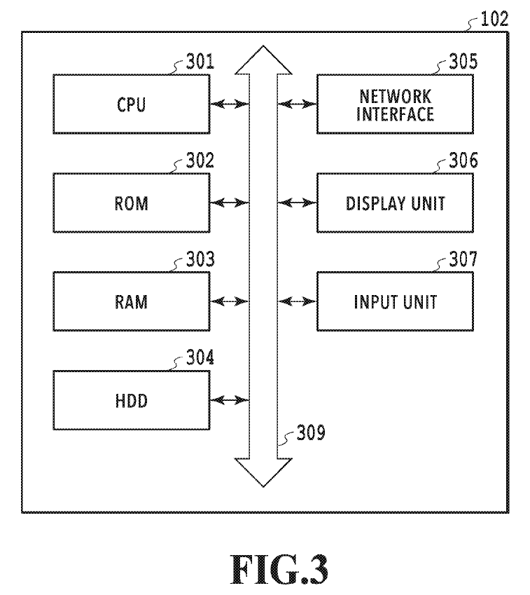

FIG. 3 is a diagram illustrating an example of the hardware configuration of an information processing apparatus that functions as the client terminal 102. The client terminal 102 is constituted by a PC (personal computer), a smartphone, a tablet terminal, or the like, and includes a CPU 301, a ROM 302, a RAM 303, an HDD 304, a network interface 305, a display unit 306, an input unit 307, and the like. Each of these units is connected via a bus 309. The CPU 301, the ROM 302, the RAM 303, and the HDD 304 function the same as the CPU 201, the ROM 202, the RAM 203, and the HDD 204 described above. The HDD 304 of the client terminal 102 stores various application programs such as a client program for the layout editing application, a print application program, a printer driver, and a web browser, and data required for processing.

The display unit 306 includes a display and a display control circuit and displays display data that is output from the CPU 301. The input unit 307 includes input devices such as a keyboard, a mouse, buttons, and a touch panel, and inputs, to the CPU 301, information and signals that are input by the user to the input devices. The network interface 305 is connected to a network such as a LAN and performs communication with the server 101 and the image output device 103. The communication method may be either wired or wireless.

It should be noted that the configurations illustrated in FIGS. 2 and 3 are examples, and not all of the illustrated configurations may be included, or configurations other than the illustrated configurations may be included. For example, it is also possible to utilize a computer having a simple configuration that does not include all of the illustrated configurations in the figures and connect the computer to another computer by using functions such as remote desktop or remote shell to remotely operate the computer, thereby causing the computer to function as an information processing apparatus. In addition, for example, in a case where a smartphone is utilized as the client terminal 102, the client terminal 102 may include configurations other than the configurations illustrated in the figure, such as a microphone for a call function, a speaker, and a camera for an imaging function.

The image output device 103 includes a CPU, a ROM, a RAM, a network interface, an input unit, an external memory, a printer, an operation panel, and the like. Each of these components is connected via a system bus. The CPU comprehensively controls each component included in the image output device 103. The CPU calls a control program stored in the ROM or a control program stored in an external memory and executes processing according to the program while utilizing the RAM as a work area. The CPU outputs an image signal as output information to the printer via the system bus. The CPU is capable of performing communication processing with the client terminal 102 via the input unit and can notify the client terminal 102 of information in the image output device 103. In addition, the CPU 200 can receive output data to be output to the printer from the client terminal 102 or the server 101 via the input unit. The RAM functions as a main memory, a work area, or the like of the CPU, and the memory capacity can be expanded by an optional RAM connected to an expansion port that is not illustrated. The external memory is a hard disk, an IC card, and the like, and can be connected as an option. The external memory stores font data, emulation programs, form data, ink used, types of fed paper, information about sizes, status information, and the like. The operation panel includes a display, a touch panel, hard keys, and the like, accepts input of operations by the user, and displays various kinds of information.

### Software Configuration

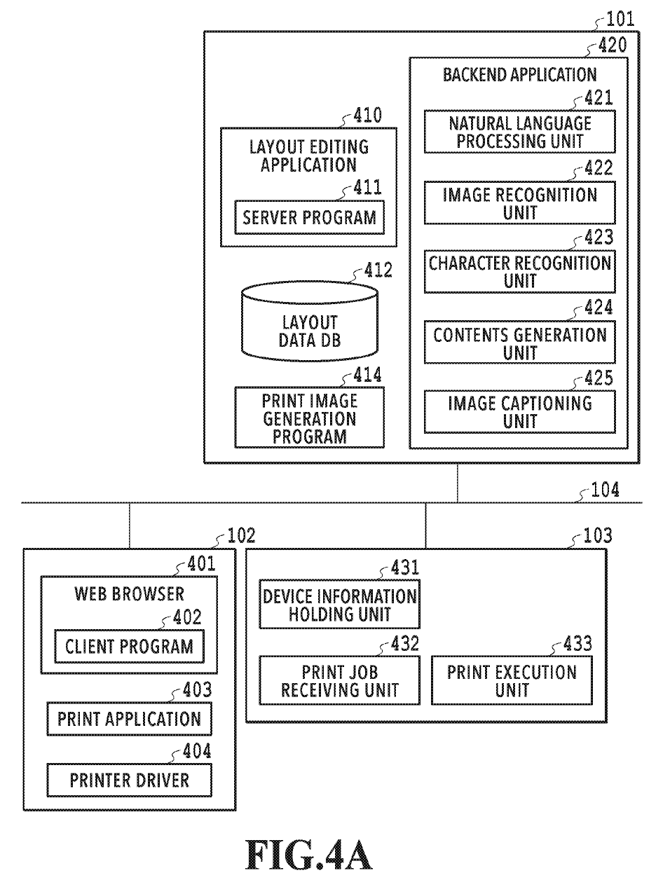

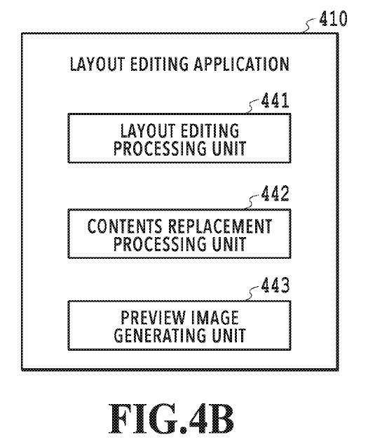

FIGS. 4A and 4B are diagrams illustrating an example of the software configuration of the information processing system 100.

The server 101 includes a server program 411 of the layout editing application 410, a backend application 420, a print image generation program 414, and the layout data DB (database) 412. These programs and data are stored in the HDD 204 of the server 101.

The layout editing application 410 is an application program for newly creating and editing layout data for products. The server 101 executes server processing in the layout editing application 410 according to the server program 411. The CPU 201 of the server 101 calls the server program 411 stored in the ROM 202 or the HDD 204 and loads the server program 411 into the RAM 203 to execute the server program 411. The server program 411 includes a program for executing various functions included in the layout editing application 410. In addition, the server program 411 includes a program that controls processing requests and responses between the server 101 and the client terminal 102, transmission and reception of data, and processing requests and responses to the backend application 420 and the print image generation program 414. The functional configuration of the layout editing application 410 will be described later.

The layout data DB 412 stores layout data created by the layout editing application 410, template data of various layouts to be used by the layout editing application 410, and the like. The layout data includes data of one or more contents that are components of the layout data. The contents include image contents and text contents. The layout data will be described later. In addition, the layout data DB 412 saves various data such as image data for printing layout data, user account data, and setting information for the layout editing application 410.

The print image generation program 414 generates image data for printing in response to a request from a print application 403 of the client terminal 102 and transmits the generated image data for printing to the print application 403 of the client terminal 102.

The backend application 420 includes a natural language processing unit 421, an image recognition unit 422, a character recognition unit 423, a contents generation unit 424, an image captioning unit 425, and the like. The backend application 420 executes processing in response to a request from the server program 411 of the layout editing application 410 and returns the processing result to the server program 411. The backend application 420 is utilized in the layout editing application 410 for generation and editing of layout data, contents replacement processing, and the like. For the backend application 420, the natural language processing unit 421, the image recognition unit 422, the character recognition unit 423, the contents generation unit 424, and the image captioning unit 425 may be mounted on one server 101 or may be separately mounted on a plurality of servers 101. In addition, the backend application 420 may use natural language processing services, image recognition services, character recognition services, contents generation services, and image captioning services provided by a service provider's server via the Internet. In addition, the backend application 420 may be installed on the client terminal 102.

The natural language processing unit 421 includes language models such as an LLM (Large Language Model) and an SLM (Small Language Model). Examples of the natural language processing unit 421 include natural language processing models such as ChatGPT [https://chatgpt.com/] and GPT-4 [https://openai.com/index/gpt-4/]. The natural language processing unit 421 understands a prompt that is input, and outputs an answer in a dialogue format. In the present embodiment, the natural language processing unit 421 is utilized for processing to extract keywords from contents, processing to determine whether or not there is an affinity between contents, processing to generate contents, and the like.

The image recognition unit 422 analyzes an input image, recognizes an object included in the input image, and outputs a caption such as the name of the object or a sentence describing the object as the recognition result. The caption is text data. The image recognition unit 422 includes an AI (Artificial Intelligence) that has been trained to detect an object included in the input image and output the detected object as text data, or an algorithm therefor.

The image captioning unit 425 includes an AI that has been trained to generate and output words and phrases and sentences describing the input image, or an algorithm therefor. The image recognition unit 422 and the image captioning unit 425 use techniques such as Image Analysis [https://learn.microsoft.com/ja-jp/azure/ai-services/computer-vision/concept-describe-images-40?tabs=image], SAM (Segment Anything Model) [https://github.com/facebookresearch/segment-anything], and Amazon Rekognition [https://aws.amazon.com/jp/rekognition/]. It should be noted that the image recognition unit 422 and the image captioning unit 425 may be able to obtain supplementary information such as an object matching rate. In this case, a first keyword extraction unit 522 may obtain the supplemental information together with a caption and store the supplemental information in the layout data DB 412 together with the caption (keyword).

The character recognition unit 423 is an OCR (Optical Character Recognition) unit and includes a service that recognizes and outputs a character string included in the input image as text data, such as Image To Text [https://www.imagetotext.info/].

The contents generation unit 424 includes an image generation model that generates image contents, and a text generation model that generates text contents. Specific examples of the image generation model include a generative AI utilizing a generative model such as Stable Diffusion [https://stability.ai/], ChatGPT, or GAN.

### Generative Adversarial Algorithm

The client terminal 102 includes a web browser 401, the print application 403, a printer driver 404, and the like. The web browser 401 is a program for realizing functions such as browsing websites on the Internet and executing web applications on the client terminal 102. In a case where a web application is executed, the web browser 401 receives a client program 402 from the server 101 and executes the received client program 402. For example, the client program 402 of the layout editing application 410 is executed. The web browser 401 interprets a script language such as HTML or JavaScript to execute the client program 402. In the present embodiment, it is assumed that the client terminal 102 executes the client program 402 of the layout editing application 410, which is a web application.

The client program 402 of the layout editing application 410 accepts layout data editing processing, contents replacement processing, preview image generation processing, and the like by the user via a UI screen displayed on the web browser 401. The editing processing of layout data includes newly creating and deleting layout data, adding, deleting, or adjusting the arrangement of contents included in layout data, newly creating contents, and the like. The client program 402 requests the server program 411 to perform a part or all of the accepted processing, receives the processing result from the server program 411, and displays the processing result on a UI screen.

The client program 402 saves layout data to be processed as a cache in the RAM 303 of the client terminal 102 or saves the layout data for each client terminal 102 in the layout data DB 412 of the server 101. In a case where user accounts exist, layout data may be saved for each user account.

The print application 403 and the printer driver 404 are programs for causing the image output device 103 to execute printing. The print application 403 obtains, from the printer driver 404, print parameters such as device information of the image output device 103, paper type, paper size, and print quality. In addition, the print application 403 obtains image data obtained by converting layout data into a layout image from the layout editing application. The print application 403 accepts editing of the print setting by the user for the obtained print parameters and generates a print job including the print setting and the layout image data. The print job is transmitted from the client terminal 102 to the image output device 103 via a spool of the printer driver 404. In a case where a print instruction for the layout data is accepted from the user, the layout editing application requests the server 101 to generate image data of a layout image for printing and obtains the image data for printing as a response. The print application 403 obtains the image data for printing, accepts the print setting from the user, generates a print job, transmits the print job to the image output device 103, and causes the image output device 103 to execute printing. In a case where the print job is generated, the print application 403 requests the layout editing application 410 to generate preview image data of the layout data or requests the print image generation program 414 of the server 101 to generate print image data.

The image output device 103 includes a device information holding unit 431, a print job receiving unit 432, and a print execution unit 433. The device information holding unit 431 holds information such as the type and remaining amount of ink installed in the image output device 103, information such as the type and size of registered paper and fed paper, status information of the image output device 103, and status information of print jobs. The print job receiving unit 432 receives a print job transmitted from the client terminal 102. The print execution unit 433 causes the printer to execute print processing according to the print job.

It should be noted that in the information processing system 100, in a case where the image output device 103 to be utilized is determined in advance, the client terminal 102 or the server 101 may obtain device information of the image output device 103 in advance and hold the device information in association with the layout data. This makes it possible to more smoothly execute creation of layout data suitable for the image output device 103, such as making it possible to select the paper type, size, available ink, and the like of printed materials that can be output by the image output device 103 and eliminating in advance the setting with which output becomes impossible.

### Layout Editing Application

Next, the functional configuration of the layout editing application 410 will be described. FIG. 4B is a diagram illustrating the functional configuration of the layout editing application 410. The layout editing application 410 is an application program for assisting the user in creating and editing layout data for products. As illustrated in FIG. 4B, the layout editing application 410 includes a layout editing processing unit 441, a contents replacement processing unit 442, a preview image generating unit 443, and the like. Each of these functional units is realized by the CPU calling a program stored in the ROM or the memory, and executing processing according to the program.

The layout editing processing unit 441 executes editing processing such as newly creating and deleting layout data, adding, deleting, and adjusting arrangement of image contents and text contents included in layout data, and newly creating contents. The layout data may be layout data created by the user, may be layout data automatically generated using a generative AI or the like, or may be template data created and stored in advance. The created and edited layout data is saved in the RAM 203 of the client terminal 102 or the layout data DB 412 of the server 101. The layout editing processing unit 441 obtains layout data to be edited from the RAM 203 of the client terminal 102 or the layout data DB 412 of the server and displays the layout data on an editing screen. The editing screen is a UI screen of the layout editing application 410 and transmits an operation instruction that is input at the client terminal 102 to the server, and displays display data transmitted from the server. The editing screen will be described later.

The contents replacement processing unit 442 executes contents replacement processing. The contents replacement processing unit 442 accepts, from the user, an instruction to replace arbitrary contents of layouts included in the layout data to be processed with another contents. Hereinafter, the contents before replacement designated by the user are referred to as the first contents, and the contents after replacement are referred to as the second contents. The contents replacement processing unit 442 replaces the first contents with the second contents based on the accepted instruction. Furthermore, the contents replacement processing unit 442 replaces other contents (third contents) in the layout data related to the first contents with appropriate contents (fourth contents). "Appropriate" means having features that are directly related to or have an affinity with the features of the second contents after replacement. In addition, the fourth contents related to the second contents are determined so as to correspond to the relationship between the first contents and the third contents. The details of the contents replacement processing unit 442 will be described later.

The preview image generating unit 443 generates preview image data by converting the layout data into an image and displays the preview image data on a preview screen. By referring to the preview image data, the user can check the printed state of the edited layout data.

### Contents Replacement Processing Unit

FIG. 5 is a diagram illustrating the functional configuration of the contents replacement processing unit 442 of the layout editing application 410. The contents replacement processing unit 442 is a functional unit included in the layout editing application 410 that is executed in the information processing system 100.

As illustrated in FIG. 5, the contents replacement processing unit 442 includes an accepting unit 510, a specifying unit 520, an obtaining unit 530, and a replacement unit 540.

The accepting unit 510 includes a first contents designation unit 511 and a second contents designation unit 512. The first contents designation unit 511 obtains the layout data to be processed from the layout data DB 412. The first contents designation unit 511 accepts, from the user, designation of the first contents, which are the contents before replacement, from among the contents included in the obtained layout data. The second contents designation unit 512 accepts, from the user, designation of the second contents, which are the contents to be arranged in the layout data instead of the first contents. In the first embodiment, it is assumed that the layout data includes at least one image content and at least one text content as the contents. In the first embodiment, it is assumed that each of the first contents and the second contents are image contents.

The specifying unit 520 specifies the third contents related to the first contents designated by the first contents designation unit 511 from among the contents included in the layout data to be processed. In the first embodiment, a case in which the third contents are text contents will be described. It should be noted that a case where the third contents are image contents will be described in a second embodiment. As illustrated in FIG. 5, the specifying unit 520 includes a first keyword extraction unit 522, a text contents obtaining unit 521, a contents keyword extraction unit 523, a determination unit 524, and a third contents specifying unit 525.

The first keyword extraction unit 522 extracts, from the image contents, which are the first contents designated by the first contents designation unit 511, one or more words or phrases or sentences that indicate the features of the image contents, as keywords. Hereinafter, a keyword extracted from the first contents is referred to as the first keyword.

The text contents obtaining unit 521 obtains the layout data to be processed from the layout data DB 412 and obtains all the text contents from among the contents included in the layout data.

The contents keyword extraction unit 523 extracts, as keywords, one or more words or phrases or sentences that indicate the features of each of the text contents obtained by the text contents obtaining unit 521. Hereinafter, a keyword of each of the text contents extracted by the contents keyword extraction unit 523 is referred to as the contents keyword.

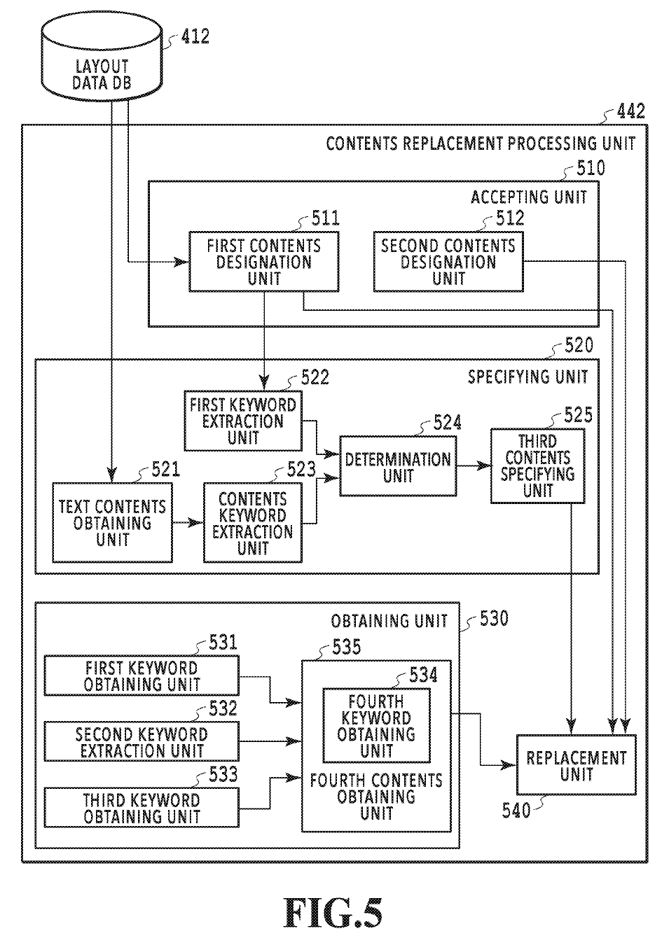

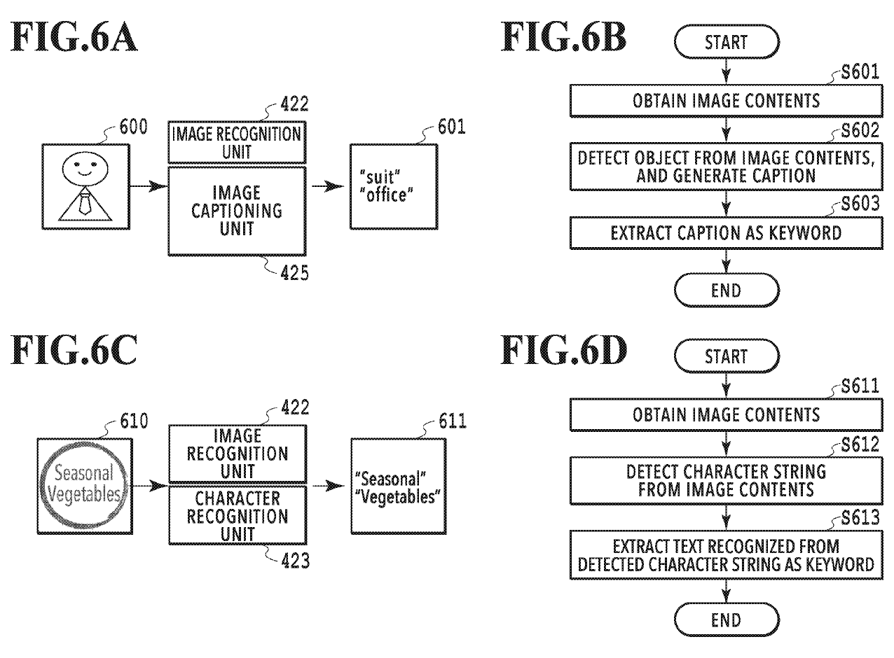

FIGS. 6A to 6D are diagrams for describing the processing of extracting keywords from image contents. FIG. 6A illustrates a case where the captions of image contents are used as keywords. FIG. 6B is a flowchart illustrating the flow of the processing to be executed by the server 101 in the case of FIG. 6A. In addition, FIG. 6C illustrates a case where a character string included in image contents is used as keywords. FIG. 6D is a flowchart illustrating the flow of the processing to be executed by the server 101 in the case of FIG. 6C.

Referring to the flowchart in FIG. 6B, a description will be given of a case where, as illustrated in FIG. 6A, words or sentences included in the caption of the image contents are used as keywords indicating the features of the image contents. It should be noted that in the following description, the processing illustrated in the flowcharts are written in a program stored in the HDD 204 of the server 101. The program is called by the CPU 201 of the server 101, loaded into the RAM 203, and executed by the CPU 201. After being started, the server 101 starts the processing illustrated in this flowchart. In the following description, the symbol "S" represents a step.

In S601, the CPU 201 (the first keyword extraction unit 522) requests at least one of the image recognition unit 422 or the image captioning unit 425 to generate a caption for image contents. At this time, the first keyword extraction unit 522 transmits the image data of image contents 600 to the image recognition unit 422 or the image captioning unit 425, along with a prompt indicating an instruction to generate a caption for the image contents 600.

In S602, the image recognition unit 422 or the image captioning unit 425 extracts features of the image data, and generates a caption (text data) that indicates what is represented by an object exhibiting the features. In the example of FIG. 6A, words and phrases such as "suit" and "office" are generated as a caption 601 from the image contents 600 illustrating a person wearing a suit.

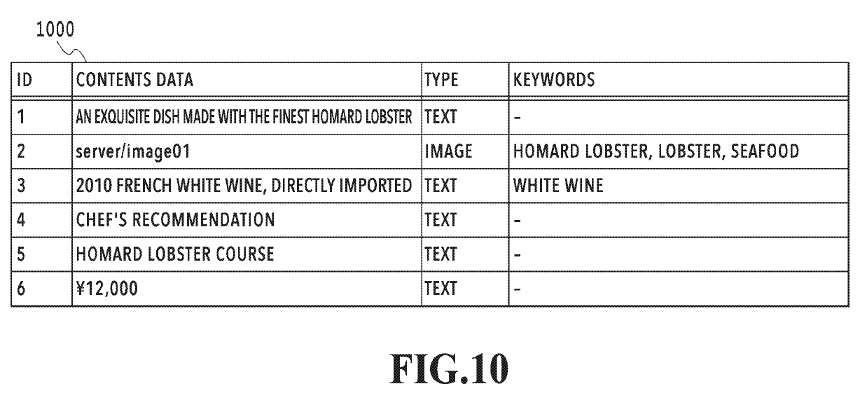

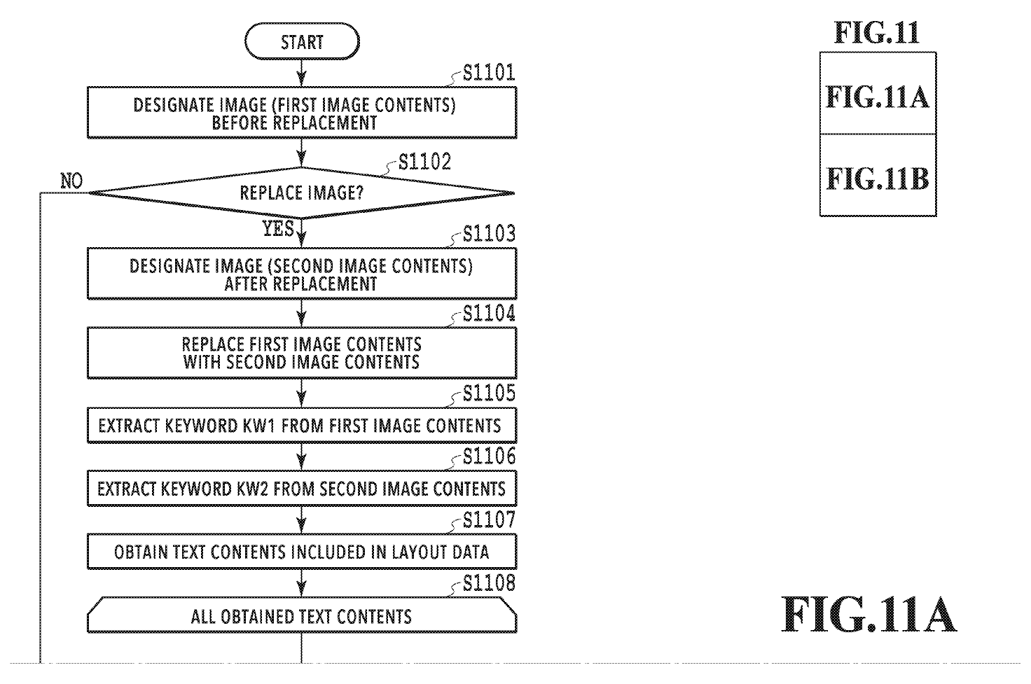

In S603, the image recognition unit 422 or the image captioning unit 425 respond, to the first keyword extraction unit 522, with the generated caption 601. The first keyword extraction unit 522 stores the obtained caption in the RAM 203 as the first keyword. Although details will be described later, it is assumed that the RAM 203 stores a data table 1000 (FIG. 10) that stores the contents ID, contents data, type, and the like of each of the contents included in the layout data. The keywords extracted from the contents are stored in association with the contents ID in the data table 1000.

Next, referring to the flowchart in FIG. 6D, a description will be given of a case where, as illustrated in FIG. 6C, the character string included in the image contents is used as keywords.

In S611, the first keyword extraction unit 522 obtains the image data of image contents 610 that includes a character string and requests the image recognition unit 422 and the character recognition unit 423 to detect the character string. At this time, the first keyword extraction unit 522 transmits the image contents 610 along with a prompt (instruction) to extract text from the image. The image recognition unit 422 can utilize, for example, Image To Text described above. The character recognition unit 423 is an OCR unit. By combining AI and OCR, it becomes possible to highly accurately extract text from images.

In S612, the image recognition unit 422 detects a character string from the image data. In S613, the character recognition unit 423 recognizes text data from the detected character string. In addition, the image recognition unit 422 may extract the recognized text data as keywords as they are or may delete unnecessary particles and auxiliary verbs from the recognized text data, and extract words and phrases exhibiting features as keywords. In the example of FIG. 6C, words 611 such as "seasonal" and "vegetables" are detected as keywords from the text data recognized as "seasonal vegetables" from the image contents 610. The image recognition unit 422 and the character recognition unit 423 respond, to the first keyword extraction unit 522, with the extracted keywords. The first keyword extraction unit 522 stores the obtained keywords as the first keywords in the data table 1000 in the RAM 203.

It should be noted that in a case of extracting keywords from image contents, the first keyword extraction unit 522 preferably performs preprocessing to generate an input image to be input to the backend application 420 such as the image recognition unit 422, the character recognition unit 423, or the image captioning unit 425.

For example, as the preprocessing, the first keyword extraction unit 522 generates an image by cutting out an image area of a representative portion of the image contents. The first keyword extraction unit 522 inputs the image of the representative portion to the backend application 420. Accordingly, since the area in which object detection is performed is narrowed down, the object recognition rate is improved. The image area of the representative portion of the image contents is determined based on, for example, the size and position of an object in the image contents. For example, the largest object among the objects detected from the image contents is determined as the representative portion. Alternatively, among the objects detected from the image contents, an object located closer to the center is determined as the representative portion. For example, in a case of an image of a plate with a main meat dish and accompanying vegetables, the area of the meat dish placed in a center portion is cut out as the representative portion.

In addition, for example, as the preprocessing, the first keyword extraction unit 522 performs rendering processing on the image of a portion of the image contents that is to be displayed in a layout, and generates a partial image. The first keyword extraction unit 522 inputs the partial image to the backend application 420. Accordingly, for example, in a case where a part of an image is cropped and arranged as image contents, and in a case where the outer edge portion of an image is masked by a frame and arranged as image contents, only the area that is finally displayed can be used for object detection. This improves the recognition rate at which the backend application 420 recognizes objects from images.

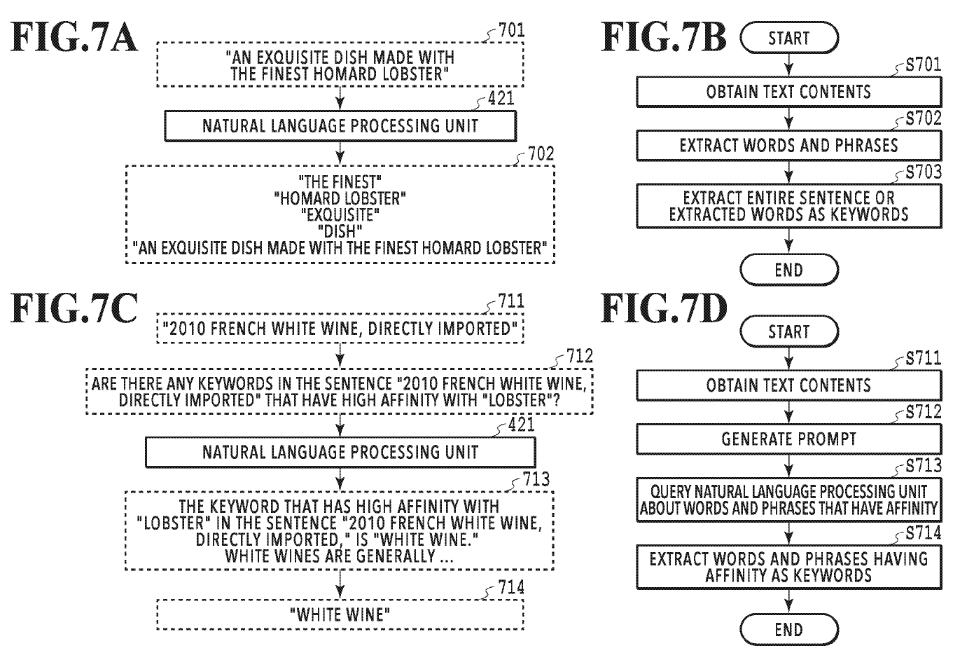

FIGS. 7A to 7D are diagrams for describing the processing of extracting keywords from text contents. FIG. 7A illustrates a case where all of the text contents or words and phrases extracted from the text contents are used as contents keywords that indicate the features of the text contents. FIG. 7B is a flowchart illustrating the flow of the processing to be executed by the server 101 in the case of FIG. 7A. In addition, FIG. 7C illustrates a case where the natural language processing unit 421 is requested to determine whether or not the text contents include a keyword that has an affinity with the first keyword, and the processing result is used as the contents keyword. FIG. 7D is a flowchart illustrating the flow of the processing to be executed by the server 101 in the case of FIG. 7C.

Referring to the flowchart of FIG. 7B, a description will be given of a case where, as illustrated in FIG. 7A, all of the text contents or the words and phrases extracted from the text contents are used as the contents keywords.

In S701, the contents keyword extraction unit 523 obtains text contents 701, and requests the natural language processing unit 421 to extract meaningful words and phrases included in the text contents 701. The natural language processing unit 421 includes an AI that has been trained to extract words and phrases included in input text data, or an algorithm therefor.

In S702, the natural language processing unit 421 performs natural language processing on the text contents 701 and extracts meaningful words and phrases. For example, in a case where the text contents 701, "An exquisite dish made with the finest Homard lobster," is input, the natural language processing unit 421 extracts words such as "the finest," "Homard lobster," exquisite," and "dish."

In S703, the natural language processing unit 421 responds, to the contents keyword extraction unit 523, with the extracted words and phrases. The contents keyword extraction unit 523 stores all of the obtained words and phrases and the text contents in the data table 1000 as contents keywords. The contents keywords are stored in association with the text contents that are the source of the contents keywords. For example, "the finest," "Homard lobster," "exquisite," "dish," and "An exquisite dish made with the finest Homard lobster" are stored as contents keywords.

Next, referring to the flowchart in FIG. 7D, a description will be given of the processing of extracting keywords that have an affinity with the first keyword from text contents as illustrated in FIG. 7C. The contents keyword extraction unit 523 requests the natural language processing unit 421 to determine whether or not the text contents include a keyword that has an affinity with the first keyword and uses the processing result as the contents keyword.

In S711, the contents keyword extraction unit 523 obtains the text contents 701.

In S712, the contents keyword extraction unit 523 generates a prompt to query the natural language processing unit 421 whether or not the text contents 701 include a keyword that has an affinity with the first keyword. As described above, the natural language processing unit 421 is a natural language processing model such as ChatGPT, and is an AI that generates answers to input prompts. For example, an example of an input prompt in a case where the text contents obtained in S711 is "2010 French white wine, directly imported" and the first keyword is "lobster" is described below.

Example prompt: "Are there any keywords in the sentence '2010 French white wine, directly imported' that have an affinity with 'lobster'?"

In this manner, the contents keyword extraction unit 523 generates a prompt by embedding the text contents and the first keyword in a predetermined sentence defined in advance. In the present specification, a predetermined sentence into which a prompt is to be embedded is referred to as a prompt template. The prompt template in this example is "Are there any keywords in the sentence ‘A’ that have an affinity with ‘B’?", where text contents are embedded into A, and the first keyword is embedded into B.

In S713, the contents keyword extraction unit 523 inputs the prompt generated in S712 to the natural language processing unit 421 and queries the natural language processing unit 421 about words and phrases that have an affinity with the first keyword in the text contents.

In S714, the natural language processing unit 421 generates an answer from the input prompt. As an answer to the prompt in the example described above, for example, "A keyword that has an affinity with 'lobster' in the sentence '2010 French white wine, directly imported' is 'white wine.' White wines are generally... (omitted)." is obtained. The natural language processing unit 421 transmits this answer to the contents keyword extraction unit 523. The contents keyword extraction unit 523 extracts the keyword "white wine" from the obtained answer, and stores "white wine" in the data table 1000 in the RAM 203 as a contents keyword. The contents keyword is stored in association with the text contents that is the source of the contents keyword.

A description of FIG. 5 will be continued. The determination unit 524 obtains one or more first keywords extracted from the first contents by the first keyword extraction unit 522. In addition, the determination unit 524 obtains one or more contents keywords extracted by the contents keyword extraction unit 523 from each of the text contents included in the layout data. The determination unit 524 determines whether or not the extracted first keyword and contents keyword are related to each other for all the text contents. In a case where it is determined that the first keyword and the contents keyword are related to each other, the text contents that are the source of the contents keyword are identified as the third contents.

The determination unit 524 determines that the first keyword and the contents keyword are "directly related" in a case where the first keyword and the contents keyword partially or exactly match. The determination unit 524 specifies the text contents that are the source of the contents keyword as the third contents. A partial match is a case where the first keyword is included in the contents keyword, or a case where the contents keyword is included in the first keyword. For example, "Homard lobster" and "lobster" have a partial match relationship. An exact match is a case where the first keyword and the contents keyword are the same, such as "lobster" and "lobster."

In addition, the determination unit 524 determines whether or not there is an affinity between the first keyword and the contents keyword, and in a case where it is determined that there is an affinity, specifies the text contents that are the source of the contents keyword as the third contents. In the present specification, "there is an affinity" means that the keywords are not in a partial or exact match relationship, but one keyword is related in meaning to the other keyword. For example, the keywords "Homard lobster" and "white wine" are not in a partial or exact match relationship. However, since seafood dishes are said to go well with white wine, "Homard lobster" is associated with "white wine," and there is an affinity between "Homard lobster" and "white wine." The determination of whether or not there is an affinity is preferably made by querying the natural language processing unit 421. As illustrated in FIG. 7C, the contents keyword extraction unit 523 may extract a sentence included in the text contents as a contents keyword as it is. The determination unit 524 generates a prompt asking whether the extracted contents keyword (sentence) includes a keyword that has an affinity with the first keyword, and inputs the prompt to the natural language processing unit 421. The determination unit 524 specifies a keyword that has an affinity with the first keyword from the answer obtained from the natural language processing unit 421.

The third contents specifying unit 525 specifies the text contents determined to be related to the first keyword as the third contents. Specifically, the third contents specifying unit 525 specifies the text contents determined to be directly related to the first keyword as the third contents. Being directly related means that the first keyword and the contents keyword of the text contents are determined to be a partial match or an exact match. In addition, the third contents specifying unit 525 specifies text contents having a contents keyword determined to have an affinity with the first keyword as third contents. In this manner, the third contents specifying unit 525 specifies one or more contents among the text contents obtained from the contents included in the layout data as the third contents related to the first keyword. The third contents specifying unit 525 saves the specified third contents in the RAM 203.

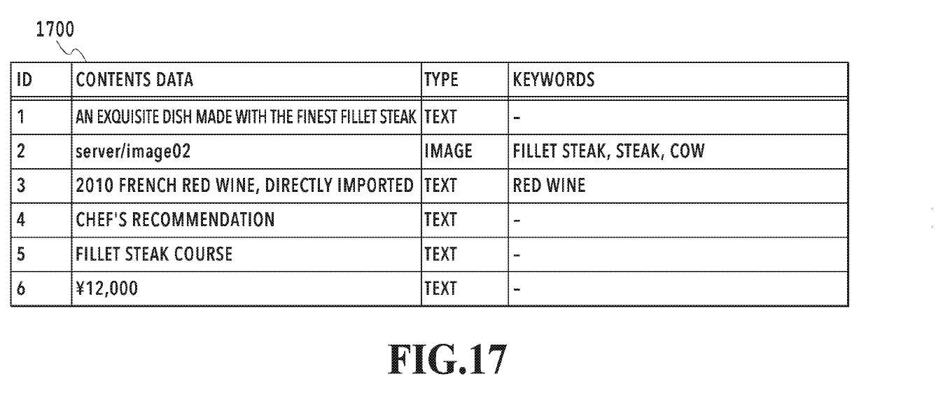

The obtaining unit 530 obtains fourth contents related to the second contents so as to correspond to the relationship between the first contents and the third contents. In the first embodiment, text contents are obtained as the fourth contents. That is, in the first embodiment, text contents that are the fourth contents related to the image contents that are the second contents are obtained, so as to correspond to the relationship between the image contents that are the first contents and the text contents that are the third contents. It should be noted that the fourth contents may be the contents generated by the obtaining unit 530, or the contents generated by the backend application 420 may be obtained by the obtaining unit 530 as the fourth contents. In addition, the contents generated by the obtaining unit 530 based on the data generated by the backend application 420 may be obtained as the fourth contents. In addition, the contents generated by an external device may be obtained by the obtaining unit 530 as the fourth contents, or the contents generated by the obtaining unit 530 based on the data generated by the external device may be obtained as the fourth contents. In a case where the relationship between the first contents and the third contents is a "directly related" relationship, the obtaining unit 530 obtains new contents directly related to the second contents as the fourth contents. In addition, in a case where the relationship between the first contents and the third contents is a relationship that "there is an affinity," the obtaining unit 530 obtains new contents having an affinity with the second contents as the fourth contents. The obtaining unit 530 stores the obtained fourth contents in a data table 1700 after replacement corresponding to the layout data after replacement. The data table 1700 after replacement (FIG. 17) will be described later.

As illustrated in FIG. 5, the obtaining unit 530 includes a first keyword obtaining unit 531, a second keyword extraction unit 532, a third keyword obtaining unit 533, and a fourth contents obtaining unit 535. The fourth contents obtaining unit 535 may further include a fourth keyword obtaining unit 534.

The first keyword obtaining unit 531 obtains the first keyword extracted by the first keyword extraction unit 522 from the data table 1000 corresponding to the layout data and inputs the first keyword to the fourth contents obtaining unit 535.

The second keyword extraction unit 532 extracts, from the image contents that are the second contents designated by the second contents designation unit 512, one or more words and phrases indicating the features of the image contents as keywords. Hereinafter, the keyword extracted from the second contents is referred to as the second keyword. The processing of extracting the second keyword is similar to the processing in the first keyword extraction unit 522 described above. That is, as illustrated in FIGS. 6A to 6D, text data obtained as the caption of the image (the second contents) or the text data of the character string included in the image is extracted as the second keyword. The second keyword extraction unit 532 inputs the extracted second keyword to the fourth contents obtaining unit 535. In addition, the extracted second keyword is associated with the second contents and stored in the data table 1700 after replacement corresponding to the layout data after replacement.

The third keyword obtaining unit 533 obtains the contents keyword included in the third contents specified by the third contents specifying unit 525 from the data table 1000 before replacement and inputs the contents keyword(the contents keyword of the third contents) to the fourth contents obtaining unit 535. The contents keyword included in the third contents is a keyword extracted by the contents keyword extraction unit 523 for the third contents.

The fourth contents obtaining unit 535 uses the first keyword, the second keyword, and the third keyword that have been input to obtain the fourth contents related to the second contents corresponding to the relationship between the first contents and the third contents.

Specifically, the fourth contents obtaining unit 535 requests the natural language processing unit 421 to generate the fourth contents. In that case, the fourth keyword obtaining unit 534 generates a prompt for obtaining the fourth contents from the natural language processing unit 421. The prompt includes the first keyword, the contents keyword of the third contents, and the second keyword. That is, the fourth keyword obtaining unit 534 generates a prompt for obtaining the fourth contents from the natural language processing unit 421 by embedding the first keyword, the contents keyword of the third contents, and the second keyword in a predetermined prompt template. An example prompt in this case is, "'White wine' goes well with 'lobster,' but what keyword goes well with 'steak'?" The prompt template in this example prompt is, for example, "'<first keyword>' goes well with '<contents keyword of the third contents>', but what keyword goes well with '<second keyword>'?"

The obtaining unit 530 (the fourth contents obtaining unit 535) may obtain (generate) the fourth contents (text contents) by replacing the contents keyword included in the third contents with the second keyword extracted from the second contents.

It should be noted that in a case where the contents keyword of the third contents include a plurality of keywords related to the first keyword, the obtaining unit 530 (the third keyword obtaining unit 533) preferably selects a contents keyword with a large number of characters. Accordingly, the keyword that captures more detailed features can be determined as the contents keyword.

In addition, in a case where there are a plurality of keywords extracted from the second contents, the obtaining unit 530 (the fourth keyword obtaining unit 534) preferably uses, as the second keyword, a keyword having a similar number of characters to the first keyword. Accordingly, layout disruption after contents replacement by the replacement unit 540 is reduced. The obtaining unit 530 holds the generated fourth contents in the data table 1700 after replacement in the RAM 203.

The replacement unit 540 obtains the first contents and the second contents designated by the user in the accepting unit 510. In addition, the replacement unit 540 obtains the third contents specified by the specifying unit 520. In addition, the replacement unit 540 obtains the fourth contents obtained by the fourth contents obtaining unit 535. The replacement unit 540 replaces the first contents with the second contents and the third contents with the fourth contents in the layout data to be processed. The layout data after replacement is stored in the layout data DB 412 as new layout data. In the first embodiment, the first contents and the second contents are image contents, and the third contents and the fourth contents are text contents. The new layout data after replacement by the replacing unit 540 is transmitted to the client terminal 102 and is displayed on the UI screen.

### UI Screen

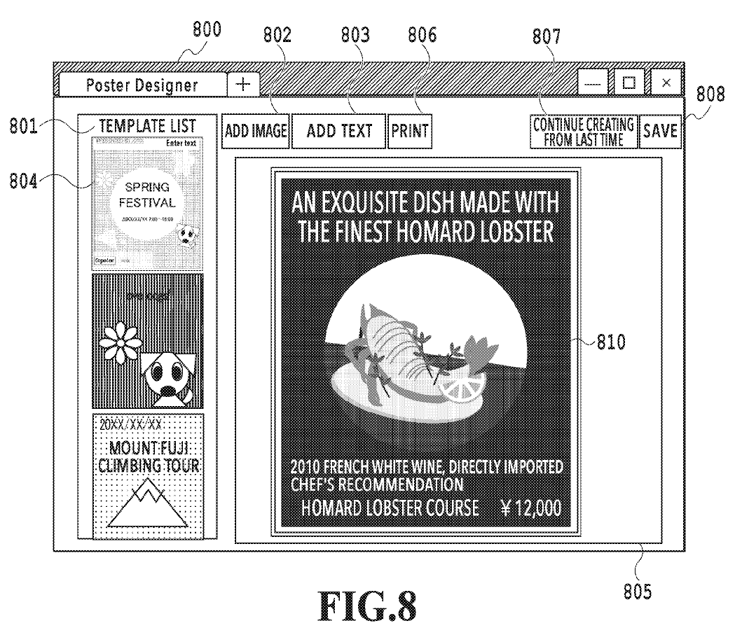

FIG. 8 is a diagram illustrating an example of an editing screen 800, which is one of UI screens of the layout editing application. The editing screen 800 is displayed on the display of the display unit 306 of the client terminal 102.

As illustrated in FIG. 8, an editing screen 800 is provided with a template list 801, an editing area 805, an add image button 802, an add text button 803, a print button 806, a "continue creating from last time" button 807, a save button 808, and the like. It should be noted that buttons corresponding to contents types other than images and text, such as an add shapes button, may further be provided.

In the template list 801, templates 804 for various products are displayed so that they can be selected. In a case where the user selects a desired template from the template list 801, the layout data of the selected template is displayed in the editing area 805 as a target for editing processing. The layout data of the template may be obtained from the layout data DB 412 of the server 101 or may be imported from an external cloud service or an SNS service that can be accessed from the client terminal 102 via the Internet.

Layout data 810 displayed in the editing area 805 includes image contents and text contents. The CPU 201 of the client terminal 102 accepts an operation via the input unit 307 for each of contents on the layout data displayed in the editing area 805. For example, the CPU 201 of the client terminal 102 accepts editing of contents by the user, such as position adjustment, cutting out, and filling of the contents, and reflects the processing result in the displayed layout data.

The add image button 802 is an operation button for adding image contents to the layout data 810 displayed in the editing area 805. In a case where the add image button 802 is pressed by the user, the CPU 201 of the client terminal 102 calls, for example, a file dialog and displays the file dialog on the display unit 306. In a case where a file is designated by the user in the file dialog, the CPU 201 of the client terminal 102 designates the path of the designated file to perform import processing.

In the present embodiment, it is assumed that in a case where the add image button 802 is pressed by the user while contents in the layout data 810 displayed in the editing area 805, for example, image contents, are selected by the user, contents replacement processing is started. The contents replacement processing will be described later.

The add text button 803 is an operation button for adding text contents to the layout data 810 displayed in the editing area 805. In a case where the add text button 803 is pressed by the user, the CPU 201 of the client terminal 102 additionally arrange text contents having no text entered on the layout data 810. By transitioning the added text contents to an active state by double-clicking a mouse, or the like, text can be input to the text contents or edited. This operation can be performed not only on text contents added by the add text button 803, but also on text contents arranged in templates and previously created layout data. The initial state of the text contents is not limited to a state with no entry but may be a state where a word or phrase that prompts entry of text is entered, such as a placeholder. In addition, similar to addition of images, arbitrary text data can be entered into the text contents. For example, the text data may be obtained from text data stored in the client terminal 102, text data stored in cloud storage, data obtained from an SNS service, or text data generated by a text generation service. In that case, the CPU 301 of the client terminal 102 displays a file dialogue or a search dialogue, accepts designation or searching of a file by the user, and performs an import processing for the designated file or data.

The print button 806 is a button that is operated in a case of printing the layout data 810. In a case where the print button 806 is pressed by the user, the CPU 301 of the client terminal 102 requests the server 101 to generate image data for printing the layout data 810 displayed in the editing area 805. In addition, the CPU 301 obtains the image data for printing from the server 101, accepts print setting, creates a print job, and transmits the print job to the image output device 103.

The "continue creating from last time" button 807 is a button that is operated in a case of creating separate layout data based on previously created layout data. In a case where the "continue creating from last time" button 807 is pressed by the user, the CPU 301 of the client terminal 102 displays a file selection dialog and accepts selection of layout data by the user. The selected layout data is displayed in the editing area 805 as a target to be processed.

The save button 808 is a button that is operated in a case of saving layout data that is being edited. In a case where the save button 808 is pressed by the user, the CPU 301 of the client terminal 102 saves the layout data 810 being edited and displayed in the editing area 805. The saving destination is, for example, the HDD 304 of the client terminal 102, the layout data DB 412 of the server 101, a predetermined storage area designated by the user, or the like. It should be noted that the CPU 301 of the client terminal 102 may perform automatic saving processing of the layout data not only in a case where the save button 808 is operated, but also at a predetermined timing, such as every time an editing operation is accepted or at a predetermined time interval. In addition, in a case where previously created layout data is called by the "continue creating from last time" button 807, the layout data that is automatically called may be newly saved as a separate file before editing is performed.

### Layout Data

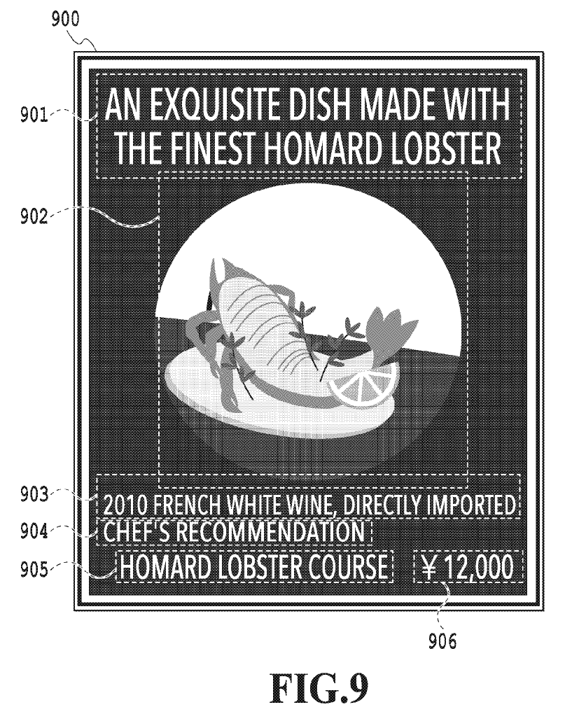

FIG. 9 is a diagram illustrating an example of layout data 900 displayed in the editing area 805 of the editing screen 800. The layout data 900 includes contents such as text contents 901, 903, 904, 905, and 906, image contents 902, and background contents. The layout data 900 is the layout data before the contents replacement processing is performed.

The text contents 901 include text data, "An exquisite dish made with the finest Homard lobster." The text contents 903 include text data, "2010 French white wine, directly imported." The text contents 904 include text data, "chef's recommendation." Text contents 905 include text data, "Homard lobster course." The text contents 906 include text data, "\12,000." These text contents 901, 903, 904,905, and 906 are arranged at predetermined positions in predetermined colors and fonts based on additional information of respective contents.

The image contents 902 are an image of a Homard lobster, and a file name such as "server/image01" and a path are saved as the data of the contents. Additional information such as the size and arrangement position of the image contents 902 is also saved as the data of the contents.

### Data Table

FIG. 10 is a diagram illustrating information of contents included in the layout data 900 illustrated in FIG. 9 in the form of the data table 1000. The data table 1000 is created for each piece of layout data and saved in the layout data DB 412. It should be noted that the data table 1000 in FIG. 10 is a data table before replacement corresponding to the layout data 900 before replacement.

As illustrated in FIG. 10, the data table 1000 stores parameters such as a contents ID for uniquely identifying each of the contents included in the layout data 900, contents data, type, and keywords. Although the data table 1000 stores additional information such as the size, position information, font, and color of each of the contents as other parameters, illustration of the additional information is omitted.

The contents data with the contents ID "1" corresponds to the text contents 901 in FIG. 9, and the type is "text." The contents data with the contents ID "2" corresponds to the image contents 902 in FIG. 9, and the file path "server/image01" is stored as the contents data. The type is "image." The contents data with the contents ID "3" corresponds to the text contents 903 in FIG. 9, and the type is "text." The contents data with the contents ID "4" corresponds to the text contents 904 in FIG. 9, and the type is "text." The contents data with the contents ID "5" corresponds to the text contents 905 in FIG. 9, and the type is "text." The contents data with the contents ID "6" corresponds to the text contents 906 in FIG. 9, and the type is "text."

The item "keywords" of the data table 1000 stores keywords extracted from contents. In a case where the type of contents is image, the caption of the image or the text data of a character string included in the image is stored as a keyword. In a case where the type of contents is text, words and phrases such as words or a sentence extracted from the contents, or keywords that have an affinity with the words and phrases included in the contents are stored. In a case where these keywords are extracted by the first keyword extraction unit 522 and the contents keyword extraction unit 523 described above, the keywords are stored in association with the original contents. It is not necessary to store keywords for all contents, and keywords extracted or generated from contents that are the processing target in the contents replacement processing are saved.

Specifically, the keywords "Homard lobster," "lobster," and "seafood" extracted from the image contents 902 (the contents ID "2") designated as the first contents are stored in the data table 1000 in FIG. 10. In addition, the keyword "white wine" extracted from the text contents 903 (the contents ID "3") specified as the third contents is stored. It should be noted that in a case where supplementary information such as an object matching rate is obtained when extracting keywords, the supplementary information may be stored in the data table 1000 in association with the keywords. Although illustration is omitted in FIG. 10, extracted keywords may also be stored for the text contents 901 (the contents ID "1") and 905 (the contents ID "5") specified as the third contents. It should be noted that the keywords extracted from the second contents, the keywords of the fourth contents, and the data of the fourth contents are held in the data table after replacement (FIG. 17).

### Contents Replacement Processing in First Embodiment

Next, the contents replacement process in the first embodiment will be described. The contents replacement processing is a part of the functions of the layout editing application 410 and is executed by the contents replacement processing unit 442.

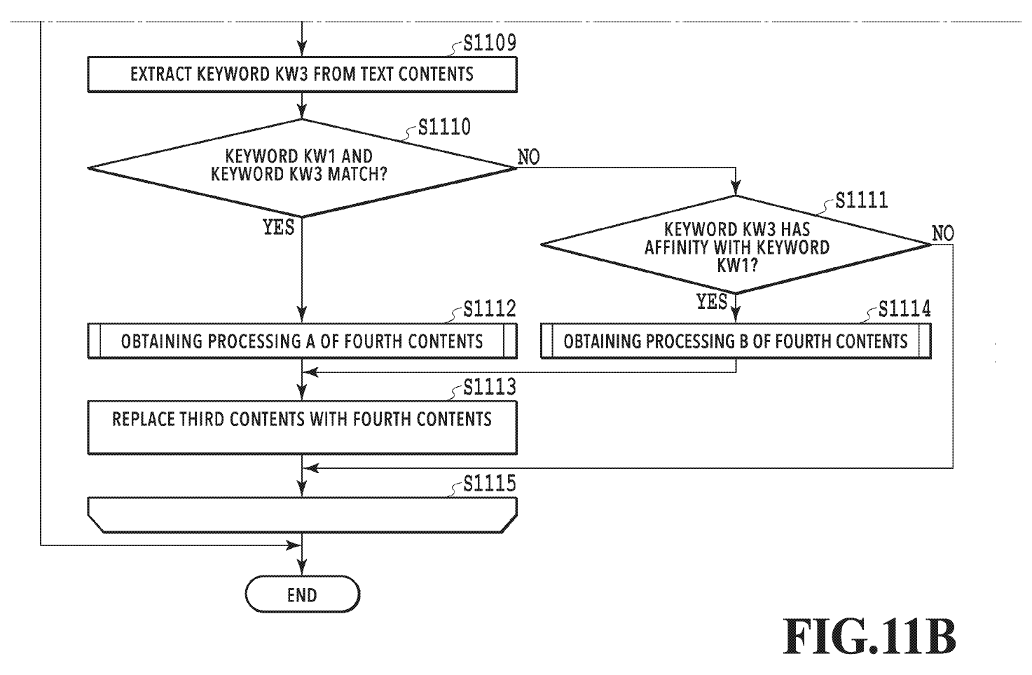

FIGS. 11A and 11B are flowcharts illustrating the flow of the contents replacement processing according to the first embodiment. In the present embodiment, it is assumed that the processing illustrated in the flowcharts of FIGS. 11A and 11B is written in the server program 411 stored in the HDD 204 of the server 101. The server program 411 is called by the CPU 201 of the server 101, loaded into the RAM 203, and executed by the CPU 201. It should be noted that in a case where the server 101 receives a request transmitted from the client terminal 102, the server 101 executes processing according to the request. The client terminal 102 executes client-side processing of the contents replacement processing according to the client program 402 that cooperates with the server program 411. For example, the client terminal 102 displays the editing screen 800, which is a UI screen, and obtains and displays, in the editing area 805, layout data to be processed from the layout data DB 412 of the server 101 according to an operation by the user on the editing screen 800. This flowchart is started with, for example, the layout data 900 of FIG. 9 displayed in the editing area 805 as the layout data to be processed.

In S1101, the CPU 201 (the first contents designation unit 511) of the server 101 obtains designation information of image contents from among the contents arranged in the layout data 900 from the client terminal 102. The image contents designated by the user from the contents are referred to as the first image contents. The designation information includes a contents ID defined in the data table 1000 of the layout data 900. The first contents designation unit 511 transmits the designation information of the first image contents to the replacement unit 540. In addition, the first contents designation unit 511 obtains the file path of the image data of the first image contents from the layout data DB 412 based on the designation information and obtains the image data of the first image contents based on the file path. The first contents designation unit 511 transmits the image data of the first image contents to the first keyword extraction unit 522.

In S1102, the CPU 201 (the second contents designation unit 512) of the server 101 determines whether or not replacement of an image is instructed from the client terminal 102. In a case where the add image button 802 is operated in the client terminal 102 with image contents selected, the second contents designation unit 512 determines that replacement of the image is instructed. In a case where the second contents designation unit 512 determines that replacement of the image is instructed from the client terminal 102 (in a case where it is determined to be YES in S1102), the second contents designation unit 512 proceeds to S1103, and in a case where the second contents designation unit 512 determines that replacement of the image is not instructed (in a case where it is determined to be NO in S1102), the second contents designation unit 512 ends the processing in the flowchart.

In S1103, the second contents designation unit 512 obtains, from the client terminal 102, the designation information of second image contents, which is the image after replacement. It is assumed that the second image contents are image data not included in the layout data displayed in the editing area 805. The second contents designation unit 512 obtains the image data of the second image contents according to the file path included in the designation information and transmits the image data to the replacement unit 540. In addition, the second contents designation unit 512 transmits the image data of the second image contents to the second keyword extraction unit 532.

In S1104, the CPU 201 (the replacement unit 540) of the server 101 replaces the first image contents with the second image contents. At this time, the replacement unit 540 generates a data table corresponding to the layout data after replacement. Hereinafter, the data table corresponding to the layout data after replacement is referred to as the data table after replacement. The data table after replacement is data obtained by duplicating the data table 1000 corresponding to the layout data 900 before replacement illustrated in FIG. 10 and changing the first image contents before replacement to the second image contents after replacement.

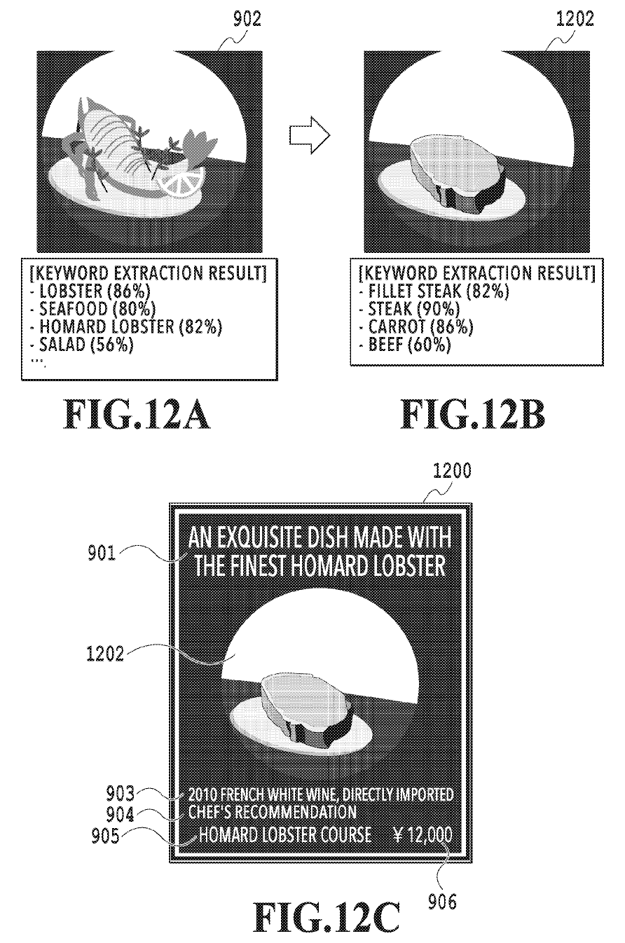

FIGS. 12A to 12C are diagrams illustrating an example of replacement of image contents in layout data. FIG. 12A illustrates the first image contents 902 before replacement, illustrating an image of a Homard lobster. FIG. 12B illustrates second image contents 1202 after replacement, illustrating an image of a fillet steak. FIG. 12C illustrates layout data 1200 in a state where the first image contents 902 have been replaced with the second image contents 1202. At this stage, only the image contents have been replaced, and the text contents 901, 903, 904, 905, and 906 are in the same state as that in the layout data 900 before replacement. In the layout data 1200, the text contents correspond to the image of Homard lobster before replacement and is not suitable for the image of fillet steak. In the subsequent processing, the specifying unit 520 of the server 101 first specifies the text contents (the third contents) related to the first image contents 902. In addition, the obtaining unit 530 obtains another text contents (the fourth contents) suitable for the second image contents after replacement. In addition, the third contents are replaced with the fourth contents by the replacement unit 540.

In S1105, the CPU 201 of the server 101 (the first keyword extraction unit 522 of the specifying unit 520) extracts, as a first keyword KW1, a word or a phrase or a sentence that indicates the features of the first image contents 902, which are the image contents before replacement. As described with reference to FIGS. 6A to 6D, the first keyword KW1 may be the caption of the image or may be a word or phrase obtained by character recognition from a character string included in the image. In the first embodiment, the first keyword extraction unit 522 requests the image recognition unit 422 or the image captioning unit 425 to generate a caption by using the first image contents 902 as an input image. As a response to this, the first keyword extraction unit 522 obtains a caption, which is text data, and sets the obtained one or more captions as the first keyword(s) KW1. The first keyword extraction unit 522 stores the extracted first keyword(s) KW1 in the item "keywords" of the data table 1000 before replacement, in association with the contents ID "2" indicating the first image contents.

It should be noted that the first keyword extraction unit 522 may obtain information of the matching rate along with the caption (keyword) from the image captioning unit 425 or the image recognition unit 422. The matching rate is a value indicating the likelihood of a caption for an input image. In that case, the first keyword extraction unit 522 may obtain a caption that satisfies a predetermined condition regarding the matching rate as the first keyword. In this manner, the accuracy of keyword extraction is improved. Although the condition for the matching rate is arbitrary, for example, a specific value such as 80% or more may be set as a threshold value. In addition, a predetermined number of captions may be obtained as keywords in descending order of the matching rate. The first keyword extraction unit 522 associates the extracted first keyword KW1 with the first image contents 902 and stores the first keyword KW1 in the data table 1000. In the example of FIG. 12A, it is assumed that "lobster (match rate 86%)," "Homard lobster (match rate 82%)," and "seafood (match rate 80%)" are extracted from the first image contents 902 as the first keywords KW1 that satisfy the condition for the match rate.

In addition, in a case where a caption that satisfies the above-described predetermined condition cannot be obtained, that is, in a case where the object detection accuracy in image recognition is not good, the first keyword extraction unit 522 may process the image data of the first image contents to narrow down a target to be analyzed. For example, the first keyword extraction unit 522 sets the image of a representative object extracted from the image data of the first image contents as an input image to the image captioning unit 425 and the image recognition unit 422. The representative object may be determined based on the size and display position of the object in the image contents. In a case where the image contents displayed in the layout data is a part of the image data, only the portion displayed in the layout data may be used as the input image. For example, there is a case where an image in which a partial area of the image data has been trimmed is displayed in the layout data as the image contents, and a case where an image masked by a frame is displayed in the layout data as the image contents. In this manner, by using the input image in which the target to be analyzed has been narrowed down, it becomes possible to extract a keyword with high accuracy.

In S1106, the CPU 201 of the server 101 (the second keyword extraction unit 532 of the obtaining unit 530) extracts a second keyword KW2 from the second image contents 1202 after replacement. The extraction method of the second keyword KW2 is the same as the extraction method of the first keyword KW1. That is, the second keyword extraction unit 532 requests the image recognition unit 422 or the image captioning unit 425 to generate a caption by using the second image contents 1202 designated by the user as an input image. As a response to this, a caption, which is text data, is obtained. The second keyword extraction unit 532 stores the extracted second keyword KW2 in the item "keywords" of the data table after replacement, in association with the contents ID "2" indicating the second image contents. It should be noted that also in extraction of the second keyword KW2, information of the matching rate may be obtained, and extraction of keyword may be performed based on the condition related to the matching rate. In addition, an image obtained by extracting a representative object from the second image contents may be input to the image captioning unit 425 and the image recognition unit 422 as the target to be analyzed. In addition, the image of a portion displayed in the layout data as the image contents may be input to the image captioning unit 425 and the image recognition unit 422 as the target to be analyzed.

In S1107, the text contents obtaining unit 521 obtains all the text contents from among the contents included in the layout data to be processed. For example, the text contents 901, 903, 904, 905, and 906 are obtained from the layout data 1200 in FIG. 12C.

S1108 to S1115 are loop processing, and are executed by the specifying unit 520, the obtaining unit 530, and the replacement unit 540 for all the text contents obtained in step S1107.

In S1109, the specifying unit 520 first sets the text contents to be processed in the loop processing. The contents keyword extraction unit 523 of the specifying unit 520 extracts a keyword from the text contents to be processed. Hereinafter, the keyword extracted from each of the contents in the loop processing is referred to as a contents keyword KW3. The contents keyword extraction unit 523 may extract an entire sentence from a character string in the text contents as the contents keyword KW3 or may extract each word and phrase from the character string divided into words, except for particles, auxiliary verbs, and the like, as the contents keyword KW3.

In S1110, the determination unit 524 determines whether the contents keyword KW3 extracted in S1109 matches the first keyword KW1 obtained in S1105. It is assumed that a match is a partial match or an exact match. In a case where it is determined to be a match (YES in S1110), the third contents specifying unit 525 specifies the text contents currently being the target of the loop processing as the third contents. Thereafter, the processing proceeds to fourth contents obtaining processing A in S1112. In a case where it is determined that the contents keyword KW3 and the first keyword KW1 are neither a partial match nor an exact match (in a case where it is determined to be NO in S1110), the processing proceeds to S1111.

In S1111, the determination unit 524 determines whether or not the contents keyword KW3 extracted in S1109 has an affinity with the first keyword KW1 extracted in S1105. In a case where it is determined that there is an affinity (in a case where it is determined to be YES in S1111), the third contents specifying unit 525 specifies the text contents currently being the target of the loop processing as the third contents, and the processing proceeds to fourth contents obtaining processing B in S1114. The processing of determining whether or not there is an affinity will be described later. In a case where it is determined that there is no affinity between the contents keyword KW3 and the first keyword KW1 (in a case where it is determined to be NO in S1111), the third contents specifying unit 525 does not specify the text contents currently being the target of the loop processing as the third contents. In addition, the fourth contents obtaining processing and replacement processing (S1113, S1114) are skipped. Thereafter, the next text contents are set to be a target to be processed, and the processing of S1109 to S1114 is repeated.

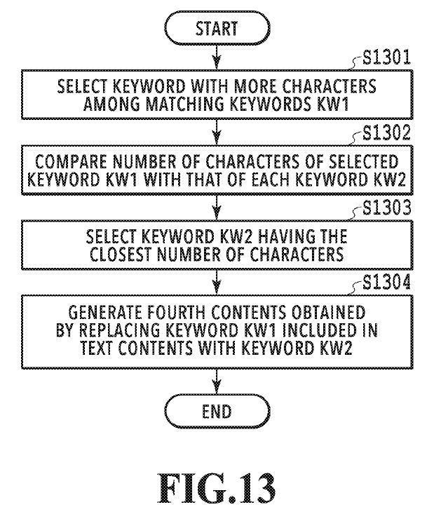

The fourth contents obtaining processing A in S1112 will be described with reference to FIG. 13.

FIG. 13 is a flowchart illustrating the flow of the fourth contents obtaining processing A. In a case where the first keyword KW1 and the contents keyword KW3 match (a partial match or an exact match), the obtaining processing A is executed by the obtaining unit 530 for the text contents (the third contents) that are the source of the contents keyword KW3.

In S1301, in a case where there is a plurality of first keywords KW1 that match the contents keyword KW3 included in the target third contents, the fourth contents obtaining unit 535 selects a keyword with more characters. This is because it is considered that more features are captured as the number of characters that match is increased. It should be noted that a match refers to a partial match or an exact match in S1110. For example, the text contents 901 "An exquisite dish made with the finest Homard lobster" specified as the third contents includes "Homard lobster" and "lobster" among the first keywords KW1. In this case, "Homard lobster" captures the features of the object better than "lobster." In a case where there is one first keyword KW1 that matches the contents keyword KW3 included in the target third contents, S1302 is skipped.

Next, the fourth contents obtaining unit 535 obtains the second keyword KW2 extracted from the second image contents in S1106. In a case where there is a plurality of second keywords KW2, one second keyword KW2 is selected by the processing in S1302.

In S1302, the fourth contents obtaining unit 535 compares the number of characters (13 characters) of the first keyword KW1 ("Homard lobster") selected in S1301 with the number of characters of each of the second keywords KW2. It is assumed that as illustrated in FIG. 12B, from the second image contents 1202, "steak" (5 characters), "fillet steak" (11 characters), and "carrot" (6 characters) are extracted as the second keywords KW2.

In S1303, the fourth contents obtaining unit 535 selects a second keyword KW2 that has a similar number of characters to the first keyword KW1. This is to prevent layout disruption in a case where the first keyword KW1 ("Homard lobster") in the third contents is replaced with the second keyword. In the case of the above-described example, "fillet steak" (11 characters) is selected as the second keyword KW2 having the closest number of characters to "Homard lobster" (13 characters). It should be noted that in a case where there is one second keyword KW2, S1303 is skipped.

In S1304, the fourth contents obtaining unit 535 replaces the first keyword KW1 "Homard lobster" selected in S1301 from the contents keywords KW3 included in the third contents with the second keyword KW2 "fillet steak" selected in S1303. Accordingly, the fourth contents, which are new text contents, are generated (obtained). In the above-described example, the first keyword KW1 "Homard lobster" included in the third contents, "An exquisite dish made with the finest Homard lobster," is replaced with "fillet steak," which has the closest number of characters among the second keywords KW2. As a result, text contents, "An exquisite dish made with the finest fillet steak," is generated (obtained) as the fourth contents. The fourth contents obtaining unit 535 inputs the generated (obtained) fourth contents to the replacement unit 540. Thereafter, the flowchart in FIG. 13 ends, and the processing proceeds to S1113 in FIG. 11B.

In S1113, the replacement unit 540 replaces the text contents to be processed (the text contents specified as the third contents) with the newly obtained fourth contents. Thereafter, the processing returns to S1109, and the processing of S1109 to S1114 is performed on the next text contents.

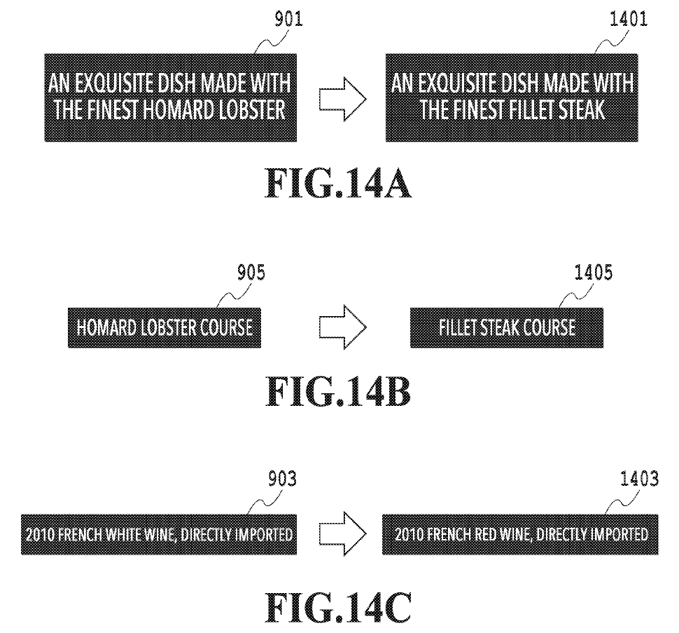

FIGS. 14A to 14C are diagrams illustrating examples of replacement of the third contents. FIGS. 14A and 14B illustrate examples of replacement of the third contents specified in S1110 as having the contents keyword KW3 that matches the first keyword KW1. The text contents 901 and 905 illustrated on the left side are the contents specified as the third contents. These third contents include the contents keyword KW3 that matches the first keyword KW1 and are therefore identified as text contents that are "directly related" to the first contents.

Text contents 1401 illustrated on the right side of FIG. 14A is the fourth contents to be arranged instead of the text contents 901, which are the third contents. The keyword "Homard lobster" in the text contents 901, "An exquisite dish made with the finest Homard lobster," is replaced with "fillet steak," which has a similar number of characters among the second keywords KW2. As a result, text contents 1401, "An exquisite dish made with the finest fillet steak," is generated and the text contents 901 is replaced with the text contents 1401.

The text contents 1405 illustrated on the right side of FIG. 14B is the fourth contents to be arranged instead of the text contents 905. The keyword "Homard lobster" in the text contents 905, "Homard lobster course," is replaced with "fillet steak," which has a similar number of characters among the second keywords KW2. As a result, the text contents 1405 "fillet steak course" is generated and the text contents 905 is replaced with the text contents 1405.

Next, the process of determining whether or not there is an affinity in S1111 will be described. The determination unit 524 queries the natural language processing unit 421 whether or not there is an affinity between the first keyword extracted in S1105 and the contents keyword KW3 extracted in S1109. In this case, the determination unit 524 embeds the first keyword KW1 and the contents keyword KW3 in a predetermined prompt template to generate a prompt for querying the natural language processing unit 421 whether or not there is an affinity. For example, in a case where the text contents currently being processed in the loop is "2010 French white wine, directly imported," the contents keyword extraction unit 523 extracts this sentence itself as the contents keyword KW3. The prompt template is, for example, "Are there any keywords in the sentence '<contents keyword KW3>' that have a high affinity with '<first keyword KW1>'?" In the case of this example, the prompt to be generated is "Are there any keywords in the sentence, '2010 French white wine, directly imported,' that have a high affinity with 'lobster'?" It should be noted that this prompt template is an example, and the expression may be arbitrary as long as it is a sentence asking whether or not there is an affinity between the contents keyword KW3 and the first keyword KW1, or which keyword among the contents keywords KW3 has an affinity with the first keyword KW1. In addition, the language is not limited to English and may be any language. In addition, in a case where there is a plurality of first keywords KW1, the determination unit 524 generates a prompt for each of the plurality of first keywords KW1 to query about the affinity with "2010 French white wine, directly imported” (the contents keyword KW3). Alternatively, a prompt including a plurality of first keywords KW1 ("Homard lobster," "lobster," "seafood") is generated to query about the affinity with "2010 French white wine, directly imported” (the contents keyword KW3).

The determination unit 524 obtains an answer from the natural language processing unit 421. For example, an answer, "The keyword that has a high affinity with 'lobster' in the sentence '2010 French white wine, directly imported," is 'white wine.' White wines are generally considered to pair very well with seafood such as lobster." is obtained. The determination unit 524 extracts "white wine" from the obtained answer as a keyword that has an affinity with the first keyword KW1. In a case where a keyword having an affinity with the first keyword KW1 is obtained from the answer, the third contents specifying unit 525 specifies the text contents 903 as the third contents. In addition, the third contents specifying unit 525 associates the keyword "white wine" extracted from the answer with the contents ID of the text contents 903, and stores "white wine" in the item "keywords" of the data table 1000.

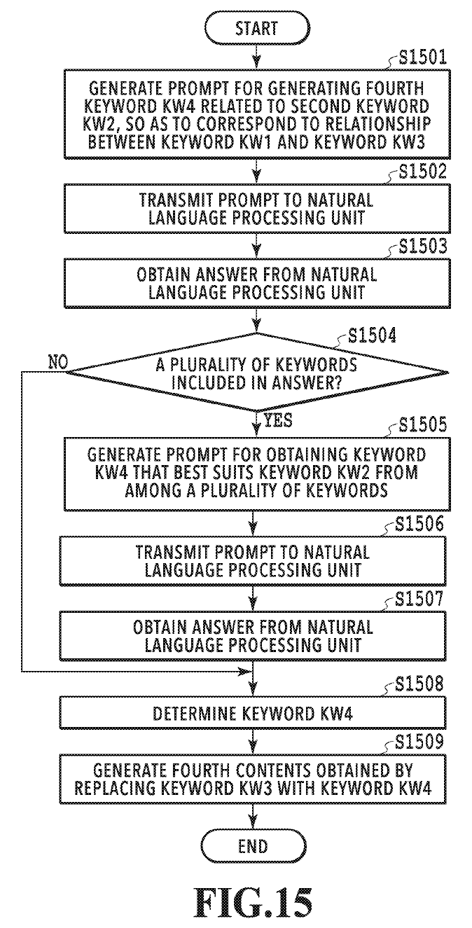

Next, the fourth contents obtaining process B in S1114 will be described with reference to FIGS. 15 to 17.

FIG. 15 is a flowchart illustrating the flow of the fourth contents obtaining processing B. The fourth contents obtaining processing B is executed by the obtaining unit 530 for the first keyword KW1 and the text contents (the third contents) including a contents keyword KW3 that has an affinity.

The obtaining unit 530 obtains the first keyword KW1 extracted in S1105, the second keyword KW2 extracted in S1106, and the contents keyword KW3 determined to have an affinity in S1111, and inputs them to the fourth keyword obtaining unit 534.

In S1501, the fourth keyword obtaining unit 534 obtains a fourth keyword KW4 related to the second keyword KW2, which corresponds to the relationship between the first keyword KW1 and the contents keyword KW3 that has an affinity with the first keyword KW1. In the present embodiment, the fourth keyword obtaining unit 534 obtains the fourth keyword KW4 by asking the natural language processing unit 421 a question.

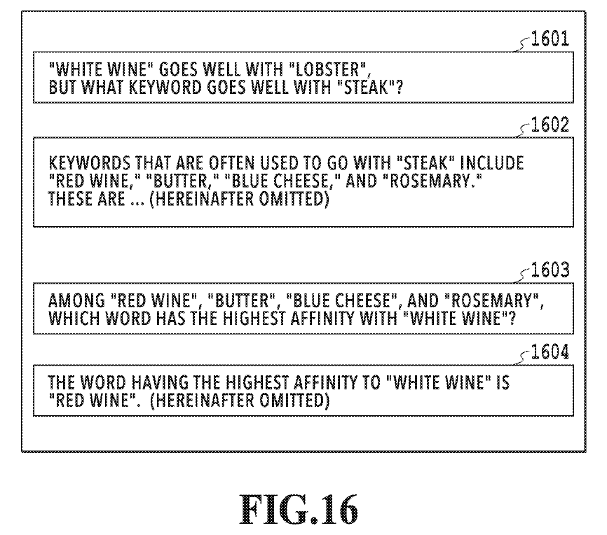

FIG. 16 is a diagram illustrating an example of a prompt that is input by the fourth keyword obtaining unit 534 to the natural language processing unit 421, and an example of an answer obtained from the natural language processing unit 421.

The fourth keyword obtaining unit 534 generates a prompt 1601 by embedding the first keyword, the contents keyword KW3 of the third contents, and the second keyword in a predetermined prompt template. The prompt 1601 to be generated is a prompt for obtaining a fourth keyword KW4 related to the second keyword KW2, which corresponds to the relationship between the first keyword KW1 and the contents keyword KW3 that has an affinity with the first keyword KW1. The prompt template may be, for example, as illustrated in FIG. 16, "'<first keyword>' matches "<contents keyword of the third contents>', but what keyword matches '<second keyword>'?" In this example, the prompt 1601 "'White wine' goes well with 'lobster', but what keyword goes well with 'steak'?" is generated. It should be noted that this prompt template is an example, and the expression may be arbitrary as long as it is a sentence for generating the fourth keyword KW4 related to the second keyword KW2, which corresponds to the relationship between the first keyword KW1 and the contents keyword KW3 that has an affinity with the first keyword KW1. In addition, the language is not limited to English and may be any language.

In S1502, the fourth keyword obtaining unit 534 transmits the prompt 1601 generated in S1501 to the natural language processing unit 421.

In S1503, the fourth keyword obtaining unit 534 obtains an answer 1602 from the natural language processing unit 421. The answer 1602 is, for example, "Keywords that are often used to go with 'steak' include 'red wine,' 'butter,' 'blue cheese,' and 'rosemary.' These are ... (hereinafter omitted)." or the like. The fourth keyword obtaining unit 534 extracts words and phrases enclosed in quotation marks (") or double quotation marks (""), or words that serve as headings, from the answer sentence. From the above-described answer 1602, words and phrases (keywords) such as "red wine," "butter," "blue cheese," and "rosemary" are extracted.

In S1504, the fourth keyword obtaining unit 534 determines whether or not the answer 1602 includes a plurality of keywords. In a case where it is determined that the answer 1602 includes a plurality of keywords, the processing proceeds to S1505. In a case where only one keyword is extracted from the answer 1602, S1505 to S1507 are skipped and the processing proceeds to step S1508.

In S1505, the fourth keyword obtaining unit 534 generates a prompt 1603 for selecting a word or phrase that has the highest affinity with the second keyword KW2 from among the keywords extracted in S1503. An example of the prompt 1603 is "Among 'red wine', 'butter', 'blue cheese', and 'rosemary', which word has the highest affinity with 'white wine'?" or the like. In this manner, keywords extracted from the previous answer 1602 are made into a list and embedded in a predetermined prompt template to generate the prompt 1603 for determining the keyword with the highest affinity. The prompt template in this case is "Which word in '<list of keywords obtained in S1503>' has the highest affinity with '<contents keyword KW3>'?" It should be noted that this prompt template is an example, and the expression may be arbitrary. In addition, the language is not limited to English and may be any language.

In S1506, the fourth keyword obtaining unit 534 transmits the prompt 1603 generated in S1505 to the natural language processing unit 421.

In S1507, the fourth keyword obtaining unit 534 obtains an answer 1604 from the natural language processing unit 421. As the answer 1604, for example, "The word having the highest affinity to 'white wine' is 'red wine'. ... (Hereinafter omitted)," or the like is obtained.

In S1508, the fourth keyword obtaining unit 534 determines a word or phrase to be the fourth keyword KW4 from the answer 1604 obtained in S1507. In the above-described example, "red wine" can be determined as the fourth keyword KW4. The fourth keyword obtaining unit 534 stores the determined fourth keyword KW4 in the item "keywords" corresponding to the contents ID of the third contents in the data table after replacement.

In S1509, the fourth contents obtaining unit 535 generates text contents by replacing the contents keyword KW3 included in the third contents with the fourth keyword KW4 determined in S1508 and obtains the generated text contents as the fourth contents. The fourth contents obtaining unit 535 stores the obtained fourth contents in the item "contents data" corresponding to the contents ID of the third contents in the data table after replacement. In this example, the fourth contents, "2010 French red wine, directly imported," generated in S1508 is stored in the item "contents data" for contents ID "3."

The fourth contents obtaining unit 535 inputs the obtained fourth contents to the replacement unit 540. In a case where the processing in S1509 ends, the flowchart of FIG. 15 ends. Then, the processing proceeds to S1113 in FIG. 11B.

FIG. 14C illustrates an example of replacement of the third contents including the contents keyword KW3 that was specified in S1111 as having an affinity with the first keyword KW1. The text contents 903 illustrated on the left side is the contents identified as the third contents. Because the third contents include the contents keyword KW3 that has an affinity with the first keyword KW1, the third contents are specified as the text contents that are in a "there is an affinity" relationship with the first contents.

The text contents 1403 illustrated on the right side of FIG. 14C are the text contents that are arranged instead of the text contents 903. The keyword "white wine" (the contents keyword KW3) in the text contents 903 "2010 French white wine, directly imported" is replaced with the newly generated fourth keyword "red wine." As a result, text contents 1403 "2010 French red wine, directly imported" is generated.

In S1113, the replacement unit 540 replaces the text contents to be processed (the text contents specified as the third contents) with the newly generated fourth contents. Thereafter, the processing returns to S1109, and the processing in S1109 to S1114 is performed on the next text contents. In a case where the loop processing in S1108 to S1115 is completed for all the text contents obtained in S1107, the flowcharts of FIGS. 11A and 11B end.

### Data Table after Replacement

FIG. 17 illustrates the data table 1700 after replacement at the stage when the contents replacement processing illustrated in FIGS. 11A and 11B ends. The data table 1700 after replacement is saved in the layout data DB 412.

### Layout Data after Replacement

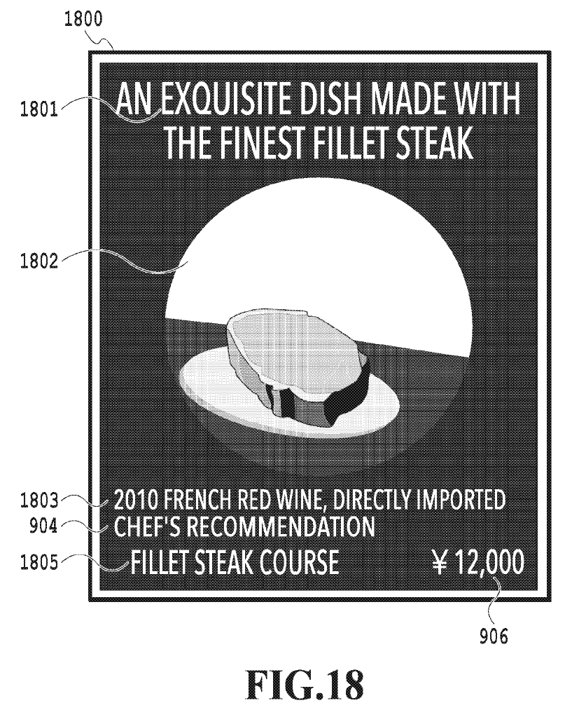

FIG. 18 is a diagram illustrating an example of display of layout data 1800 after replacement corresponding to the data table 1700 after replacement illustrated in FIG. 17.

As illustrated in FIG. 17, the data table 1700 after replacement stores the contents ID for identifying each of the contents included in the layout data after replacement, contents data, type, and keywords. The contents data with the contents ID "1" corresponds to text contents 1801 in FIG. 18, and the type is "text." The contents data with the contents ID "2" corresponds to image contents 1802 in FIG. 18, and the file path "server/image02" is stored in the contents data. The type is "image." The contents data with the contents ID "3" corresponds to text contents 1803 in FIG. 18, and the type is "text." The contents data with the contents ID "4" corresponds to text contents 904 in FIG. 18, and the type is "text." The contents data with the contents ID "5" corresponds to text contents 1805 in FIG. 18, and the type is "text." The contents data with the contents ID "6" corresponds to text contents 906 in FIG. 18, and the type is "text." It should be noted that in FIG. 18, the same contents as those in the layout data 900 illustrated in FIG. 9 are denoted by the same numerals as those illustrated in FIG. 9. The text contents 904 and 906 are not determined to be related to the first image contents before replacement in the determination in S1110 or S1111 and therefore are not specified as the third contents and maintain the state of the original layout data.

The layout data 900 before replacement illustrated in FIG. 9 is compared with the layout data 1800 after replacement illustrated in FIG. 18. The first image contents 902 before replacement have been replaced with the second image contents 1802. This replacement processing is performed in S1101 to S1104 by the user's designation operation and the replacement unit 540. As the third contents related to the first image contents 902, the text contents 901, 903, and 905 are specified. This specifying processing is performed by the specifying unit 520 in steps S1107 to S1111.

The text contents 901 have been replaced by the text contents 1801 in FIG. 18. The text contents 1801 are the fourth contents obtained by the fourth contents obtaining processing A illustrated in FIG. 13. The first keyword KW1 (Homard lobster) directly related to the first image contents has been replaced with the second keyword KW2 (fillet steak) extracted from the second image contents after replacement.

The text contents 903 have been replaced by the text contents 1803 in FIG. 18. The text contents 1803 are the fourth contents obtained by the fourth contents obtaining processing B illustrated in FIG. 15. The contents keyword KW3 (white wine) that has an affinity with the first image contents (the image of a lobster) has been replaced with the fourth keyword KW4 (red wine) that has an affinity with the second image contents (the image of steak) after replacement.

The text contents 905 have been replaced with the text contents 1805 in FIG. 18. The text contents 1805 are the fourth contents obtained by the fourth contents obtaining processing A illustrated in FIG. 13. The phrase (Homard lobster) directly related to the first image contents have been replaced with the second keyword KW2 (fillet steak) extracted from the second image contents after replacement.

The replacement processing of these text contents is executed by the replacement unit 540 in S1113. The text contents 904 and 906 are determined not to be related to the first image contents 902, are not replaced, and are the same as those in the layout data 900 before replacement.

As described above, the layout editing application 410 illustrated in the first embodiment includes the contents replacement processing unit 442 and executes the contents replacement processing in a case where the user designates image contents included in layout data to replace it with another image contents. The contents replacement processing unit 442 specifies the text contents (the third contents) directly related to the image contents before replacement from among the contents included in the layout data. In addition, the texts contents are replaced with the text contents (the fourth contents) corresponding to the image contents after replacement. Furthermore, the contents replacement processing unit 442 specifies the text contents (the third contents) that have an affinity with the image contents before replacement. In addition, new text contents (the fourth contents) related to the image contents after replacement are generated (obtained), and the third contents are replaced with the fourth contents. Accordingly, in conjunction with the replacement of a part of the contents in the layout data, the other related contents are also changed to appropriate contents. Thus, the workload of editing the layout data is reduced, and the usability is improved.

### Modification 1

In the fourth contents obtaining processing B in S1114, in a case where a plurality of fourth keywords KW4 having an affinity with the second keyword KW2 are obtained, in the above-described example, the server 101 determines one fourth keyword KW4 by the processing in S1505 to S1507 in FIG. 15. However, the processing is not limited to this, and a selection by the user may be accepted.

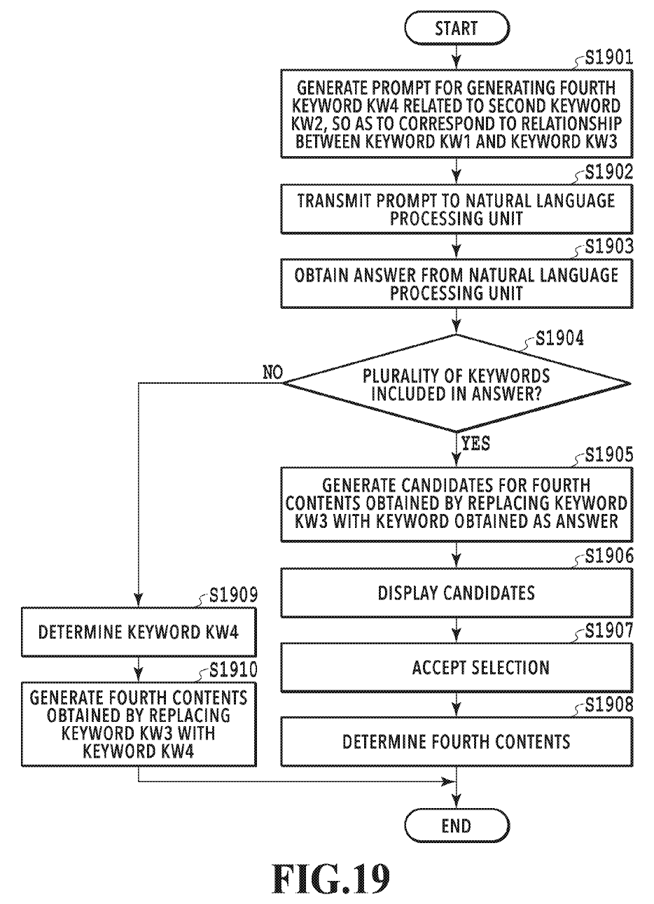

FIG. 19 is a flowchart illustrating a modification of the fourth contents obtaining processing B. This flowchart illustrates the processing that is executed instead of the flowchart of FIG. 15 in the first embodiment. The obtaining unit 530 executes the processing illustrated in FIG. 19 on the text contents (the third contents) including the contents keyword KW3 that has an affinity with the first keyword KW1. In the flowchart of FIG. 19, S1901 to S1904, S1909, and S1910 are the same as S1501 to S1504, S1508, and S1509, respectively. Hereinafter, a description will be mainly given of S1905 to S1908, which is processing different from the flowchart of FIG. 15.

In S1901 to S1903, the fourth keyword obtaining unit 534 obtains a fourth keyword KW4 related to the second keyword KW2 by asking the natural language processing unit 421 a question. The fourth keyword obtaining unit 534 stores a plurality of fourth keywords KW4 in the item "keywords" corresponding to the contents ID of the third contents in the data table after replacement.

In S1904, in a case where it is determined that the obtained answer includes a plurality of keywords, the processing proceeds to the processing in S1905. It is assumed that, for example, the answer includes keywords such as "red wine," "butter," "blue cheese," and "rosemary."

In S1905, the fourth contents obtaining unit 535 generates a plurality of fourth contents by using each of the keywords obtained as the answer. The fourth contents obtaining unit 535 generates a plurality of text contents by replacing the contents keyword KW3 included in the third contents with each of the keywords obtained as the answer and sets the generated text contents as candidates for the fourth contents.

In S1906, the fourth contents obtaining unit 535 displays the candidates for the fourth contents on the editing screen 800. The client terminal 102 displays, on the display unit 306, a selection UI 2000 for selecting any one of the candidates for the fourth contents.

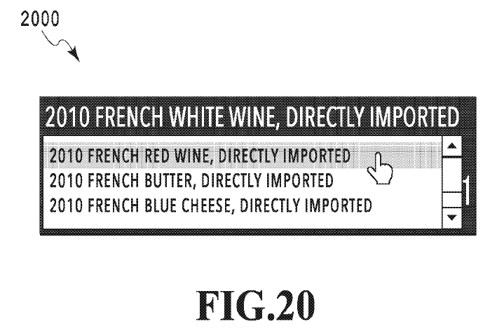

FIG. 20 is a diagram illustrating an example of the selection UI 2000 displayed on the client terminal 102. In the example of FIG. 20, although the selection UI 2000 in a pull-down format is illustrated, the format is not limited to this. The selection UI 2000 displays, as the candidates for the fourth contents, "2010 French red wine, directly imported," "2010 French butter, directly imported," "2010 French blue cheese, directly imported," and the like. It should be noted that the selection UI 2000 may include and display the third contents before replacement as they are.

In S1907, the fourth contents obtaining unit 535 accepts selection of a candidate by the user via the selection UI 2000 and obtains the accepted selection information from the client terminal 102.

In S1908, the fourth contents obtaining unit 535 determines the fourth contents to be reflected in the layout according to the selection information. The fourth contents obtaining unit 535 inputs the determined fourth contents to the replacement unit 540. In a case where S1908 or S1910 ends, the flowchart of FIG. 19 ends. Thereafter, the processing proceeds to S1113 of FIG. 11B. In S1113, the replacement unit 540 replaces the third contents with the fourth contents determined through the selection by the user.

The answer from the natural language processing unit 421 is not necessarily correct. Therefore, as illustrated in Modification 1, by allowing the user to select the fourth contents after replacement, it becomes possible to generate the layout data that is aligned with the user's intention.

### Modification 2

In the first embodiment, the example has been described in which the first contents and the second contents designated by the user are image contents, however the first contents and the second contents may be text contents. That is, in a case where replacement of the text contents in the layout data is executed according to an operation by the user, the server 101 specifies other related text contents (the third contents) from among the contents included in the layout data. Then, the text contents are replaced with the text contents (the fourth contents) corresponding to the text contents (the second contents) after replacement.

In Modification 2, the system configuration of the information processing system 100, and the hardware and functional configurations of the server 101 and the client terminal 102 are the same as those in the first embodiment (FIGS. 2 to 5). However, the processing in the first keyword extraction unit and the second keyword extraction unit is changed to processing of extracting keywords from text contents.

For example, it is assumed that the layout data 900 illustrated in FIG. 9 is the layout data before replacement. It is assumed that, by a user's designation operation, the text contents 901 (the first contents), "An exquisite dish made with the finest Homard lobster," are replaced with the text contents (the second contents), "An exquisite dish made with the finest fillet steak."

In this case, the first keyword extraction unit 522 extracts, for example, "Homard lobster," from the text contents (the first contents) before replacement as the first keyword KW1. In addition, the second keyword extraction unit 532 extracts, for example, "fillet steak," from the text contents (the second contents) after replacement as the second keyword KW2.

The processing of specifying the third contents by the specifying unit 520 is the same as that in the first embodiment. Among the text contents included in the layout data 900 before replacement, the text contents including the contents keyword KW3 that matches or has an affinity with the first keyword KW1 (Homard lobster) are specified as the third contents. As in the first embodiment, the directly related text contents 905, "Homard lobster course," and the text contents 903 having an affinity, "2010 French white wine, directly imported," are identified as the third contents.

The process of obtaining the fourth contents by the obtaining unit 530 is also the same as that in the first embodiment. The fourth contents obtaining unit 535 generates the fourth contents related to the second contents by the fourth contents obtaining processing A illustrated in FIG. 13 or the fourth contents obtaining processing B illustrated in FIG. 15. For example, as the fourth contents to replace the text contents 905, "Homard lobster course," specified as the third contents, "fillet steak course" is generated by text replacement. In addition, as the fourth contents to replace the text contents 903, "2010 French white wine, directly imported," specified as the third contents, "2010 French red wine, directly imported" is generated by using the natural language processing unit 421.

The replacement processing by the replacement unit 540 is also the same as that in the first embodiment. The replacement unit 540 replaces the first contents, which are text contents, with the second contents, which are text contents, and replaces the text contents (the third contents) related to the first contents with the text contents (the fourth contents) related to the second contents.

As described above, according to Modification 2, even in a case where the user specifies the text contents included in the layout data to replace it with another text contents, the contents replacement processing is executed in the same manner as in the first embodiment. That is, the contents replacement processing unit 442 specifies the text contents (the third contents) directly related to the text contents before replacement from among the contents included in the layout data. In addition, the text contents are replaced with the text contents (the fourth contents) corresponding to the text contents after replacement. Furthermore, the contents replacement processing unit 442 specifies the text contents (the third contents) that have an affinity with the text contents before replacement. In addition, new text contents (the fourth contents) related to the text contents after replacement are generated, and the third contents are replaced with the fourth contents. Accordingly, in conjunction with the replacement of a part of the contents in the layout data, the other related contents are also changed to appropriate contents. Thus, the workload of editing the layout data is reduced, and the usability is improved.

It should be noted that also in Modification 2, as illustrated in Modification 1, the selection of the fourth contents to be replaced may be accepted from the user.

### Second Embodiment

In the first embodiment, the processing has been described that, in a case where the first contents are replaced with the second contents according to a user's instruction, replaces the text contents related to the first contents with the text contents related to the second contents. However, there may also be image contents related to the first contents among the contents included in the layout data. Therefore, in the second embodiment, a case will be described where the third contents and the fourth contents are image contents. As an example, a case will be described where the user specifies the first image contents from the layout data and replaces the first image contents with the second image contents. The contents replacement processing unit of the server 101 specifies, as the third contents, the image contents related to the first image contents from among the contents included in the layout data. Then, the third contents are replaced with the fourth contents that are the image contents related to the second image contents. The image contents related to the first image contents include image contents including the contents keyword KW3 that partially or exactly matches the first keyword KW1 extracted from the first image contents, and image contents that has an affinity with the first image contents.

In the second embodiment, the system configuration of the information processing system 100 and the hardware configurations of the server 101 and the client terminal 102 are the same as those in the first embodiment (FIGS. 2 and 3). In addition, the software configuration of the information processing system 100 and the functional configuration of the layout editing application 410 are also the same as those in the first embodiment (FIG. 4). However, a part of the processing executed by the contents replacement processing unit is different.

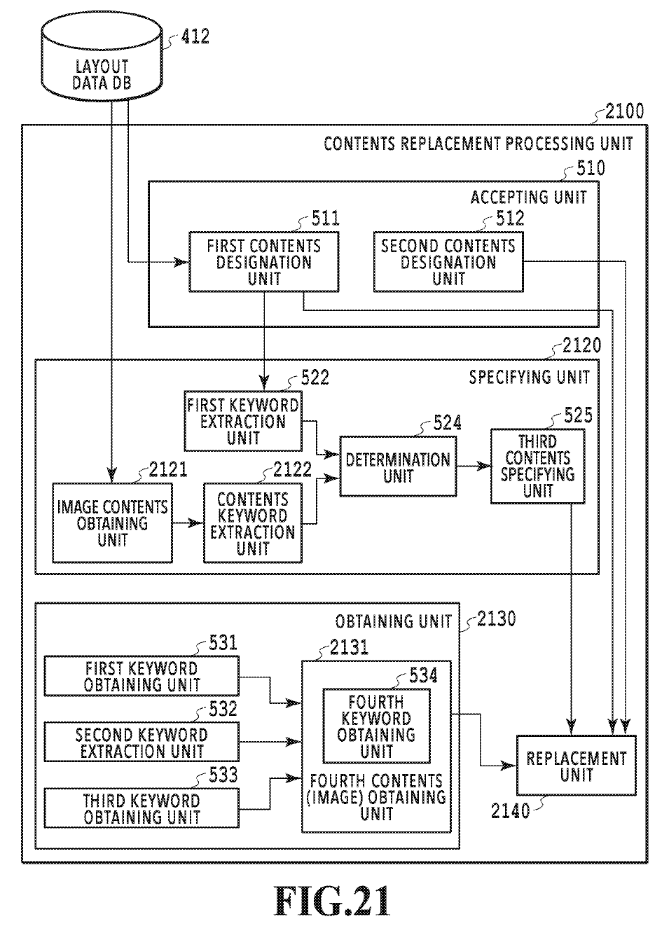

FIG. 21 is a diagram illustrating the functional configuration of a contents replacement processing unit 2100 in the second embodiment. In FIG. 21, the same units as those in the contents replacement processing unit 442 in the first embodiment are denoted by the same numerals.

The contents replacement processing unit 2100 includes an accepting unit 510, a specifying unit 2120, an obtaining unit 2130, and a replacement unit 2140. The accepting unit 510 is the same as that in the first embodiment.

The specifying unit 2120 specifies the third contents related to the first contents designated by the first contents designation unit 511 from among the contents included in the layout data to be processed. In the second embodiment, a case will be described where the third contents are image contents. That is, the specifying unit 2120 in the second embodiment includes an image contents obtaining unit 2121 instead of the text contents obtaining unit 521 in the first embodiment. In addition, a contents keyword extraction unit 2122 extracts, as keywords, one or more words and phrases or a sentence that indicates the features of each of the image contents obtained by the image contents obtaining unit 2121. The keywords of each of the image contents extracted by the contents keyword extraction unit 2122 are called contents keywords. The image contents obtaining unit 2121 and the contents keyword extraction unit 2122 in the second embodiment will be described later. The first keyword extraction unit 522, the determination unit 524, and the third contents specifying unit 525 are the same as those in the first embodiment.

The obtaining unit 2130 generates the fourth contents related to the second contents, so as to correspond to the relationship between the first contents and the third contents. In the second embodiment, image contents are generated as the fourth contents. That is, in the second embodiment, image contents that are the fourth contents related to the image contents that are the second contents are generated, so as to correspond to the relationship between the image contents that are the first contents and the image contents that are the third contents. In a case where the relationship between the first contents and the third contents is a "directly related" relationship, the obtaining unit 2130 obtains new contents directly related to the second contents as the fourth contents. In addition, in a case where the relationship between the first contents and the third contents is a relationship that "there is an affinity," new contents having an affinity with the second contents are obtained as the fourth contents.

The first keyword obtaining unit 531, the second keyword extraction unit 532, the third keyword obtaining unit 533, and the fourth keyword obtaining unit 534 of the obtaining unit 2130 in the second embodiment are the same as those in the first embodiment.

The replacement unit 2140 obtains the first contents and the second contents designated by the user in the accepting unit 510. In addition, the replacement unit 2140 obtains the third contents (the image contents) specified by the specifying unit 2120. In addition, the replacement unit 2140 obtains the fourth contents (the image contents) obtained by the fourth contents obtaining unit 2131. The replacement unit 2140 replaces the first contents with the second contents and the third contents with the fourth contents in the layout data to be processed. The layout data after replacement is stored in the layout data DB 412 as new layout data. In the second embodiment, the first contents and the second contents are image contents, and the third contents and the fourth contents are also image contents. The new layout data after replacement by the replacement unit 2140 is transmitted to the client terminal 102 and displayed on the UI screen.

### Layout Data

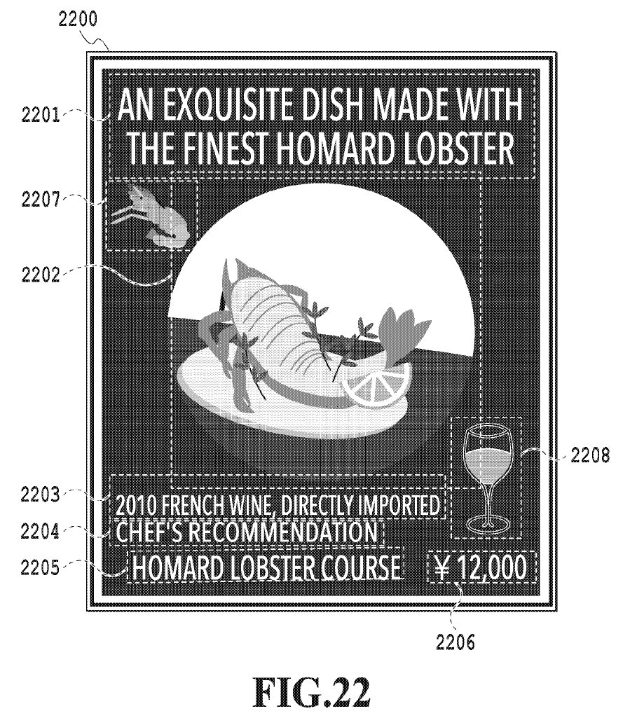

FIG. 22 is a diagram illustrating an example of layout data 2200 to be edited in the second embodiment. The layout data 2200 includes five text contents 2201, 2203, 2204, 2205, and 2206, and three image contents 2202, 2207, and 2208.

### Data Table

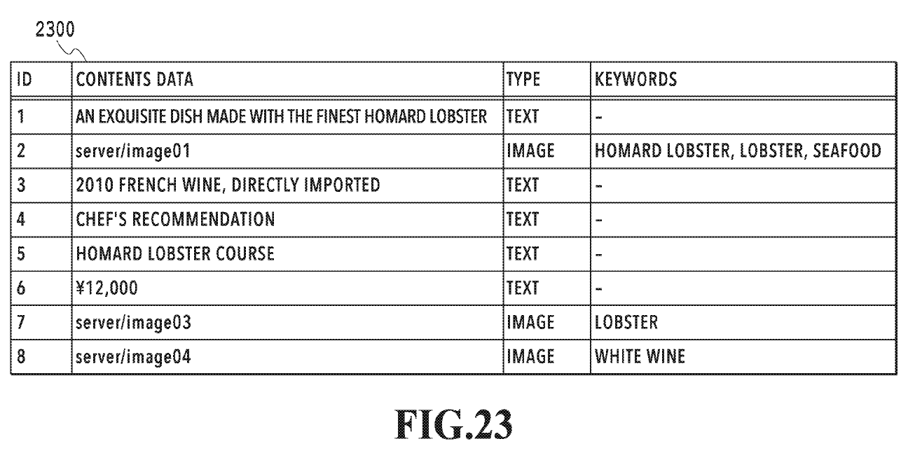

FIG. 23 is a diagram illustrating information of each of the contents included in the layout data 2200 illustrated in FIG. 22 in the form of a data table 2300. As in the first embodiment, the data table 2300 stores parameters such as the contents ID for uniquely identifying each of the contents included in the layout data 2200, contents data, type, and keywords. Although the data table 2300 stores additional information such as the size, position information, font, and color of each of the contents as the other parameters, illustration of the additional information is omitted.

In the data table 2300, the contents data with the contents ID of "1" corresponds to the text contents 2201 in FIG. 22, and the type is "text." The contents data with the contents ID "2" corresponds to the image contents 2202 in FIG. 22, and the file path "server/image01" is stored as the contents data. The type is "image." "Homard lobster, lobster, seafood" are stored as the keywords corresponding to the image contents 2202. Similarly, the data table 2300 stores data relating to each of the contents included in the layout data 2200 before replacement.

### Contents Replacement Processing in Second Embodiment

Next, the contents replacement processing in the second embodiment will be described. The contents replacement processing is a part of the functions of the layout editing application 410, and is executed by the contents replacement processing unit 2100.

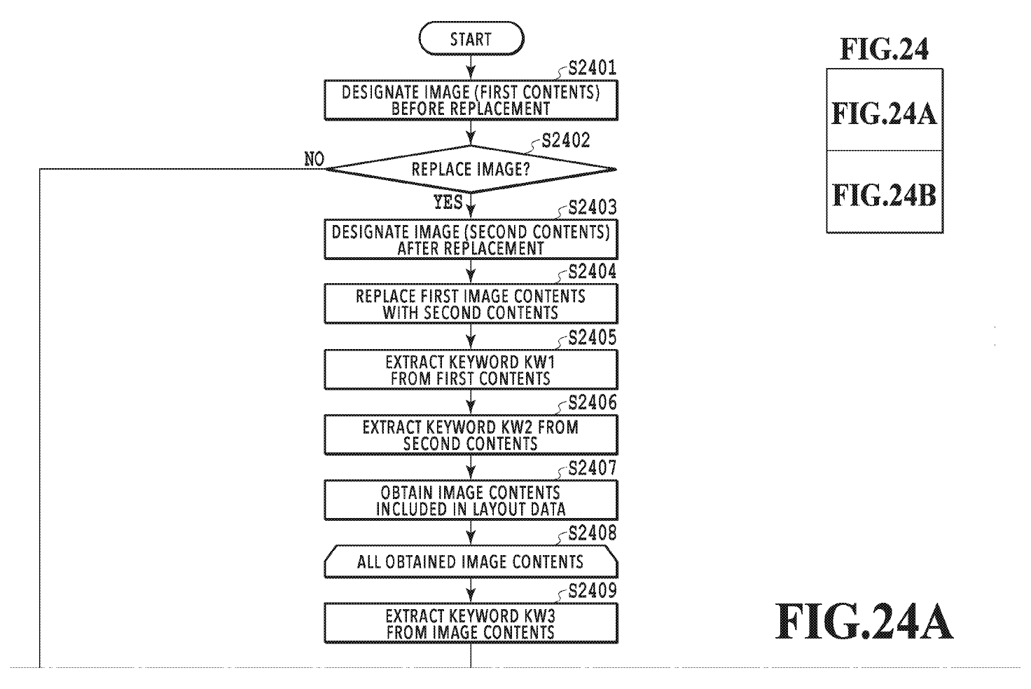

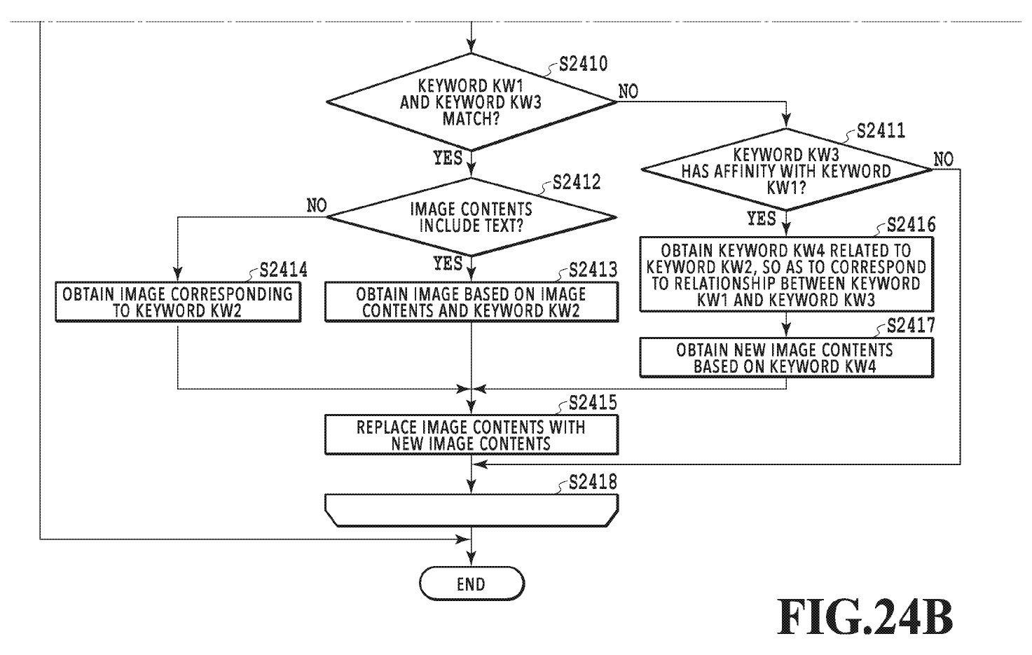

FIGS. 24A and 24B are flowcharts for describing the flow of the contents replacement processing according to the second embodiment. It is assumed that, as in the first embodiment, the processing illustrated in the flowcharts of FIGS. 24A and 24B are written in the server program 411 stored in the HDD 204 of the server 101. The server program 411 is called by the CPU 201 of the server 101, loaded into the RAM 203, and executed by the CPU 201. It should be noted that in a case where the server 101 receives a request transmitted from the client terminal 102, the server 101 executes processing according to the request. The client terminal 102 executes the client-side processing of the contents replacement processing according to the client program 402 that cooperates with the server program 411. The editing screen, which is the UI screen for the contents replacement process, is also the same as that in the first embodiment. The flowchart starts in a state where, for example, the layout data 2200 illustrated in FIG. 22 is displayed in the editing area of the editing screen as the layout data to be processed.

S2401 to S2406 in the flowchart of FIG. 24A are the same as S1101 to S1106 in the contents replacement processing (FIG. 11A) in the first embodiment. Hereinafter, the differences from the first embodiment will be mainly described.

In S2401, the CPU 201 (the first contents designation unit 511) of the server 101 obtains the designation information of image contents from among the contents arranged in the layout data 2200 from the client terminal 102. The image contents designated by the user from the contents is referred to as the first image contents, as in the first embodiment. The first contents designation unit 511 transmits the designation information of the first image contents to the replacement unit 2140. In addition, the first contents designation unit 511 obtains the file path of the image data of the first image contents from the layout data DB 412 based on the designation information and obtains the image data of the first image contents based on the file path. The first contents designation unit 511 transmits the image data of the first image contents to the first keyword extraction unit 522. For example, it is assumed that the image contents 2202 in the layout data 2200 are designated as the first image contents.

In S2402, the CPU 201 (the second contents designation unit 512) of the server 101 determines whether or not replacement of an image is instructed from the client terminal 102. In a case where the add image button 802 is operated in the client terminal 102 in a state where image contents have been selected, the second contents designation unit 512 determines that replacement of the image is instructed. In a case where the second contents designation unit 512 determines that replacement of the image is instructed from the client terminal 102 (YES in S2402), the processing proceeds to S2403, and in a case where the second contents designation unit 512 determines that replacement of the image is not instructed (NO in S2402), the processing in this flowchart ends.

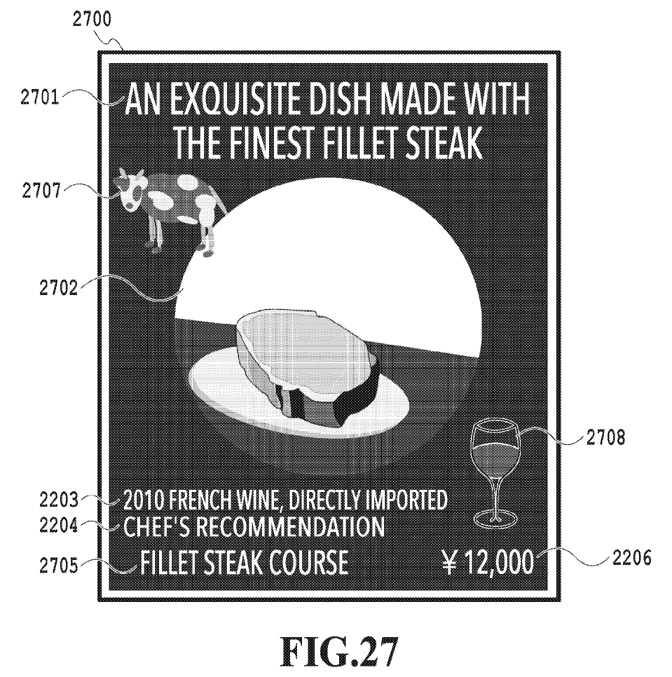

In S2403, the second contents designation unit 512 obtains the designation information of the second image contents, which is the image after replacement, from the client terminal 102. It is assumed that the second image contents are image data that is not included in the layout data displayed in the editing area 805. The second contents designation unit 512 obtains the image data of the second image contents according to the file path included in the designation information and transmits the image data to the replacement unit 2140. In addition, the second contents designation unit 512 transmits the image data of the second image contents to the second keyword extraction unit 532. For example, it is assumed that an image of a fillet steak (2702 in FIG. 27) is designated as the second image contents.

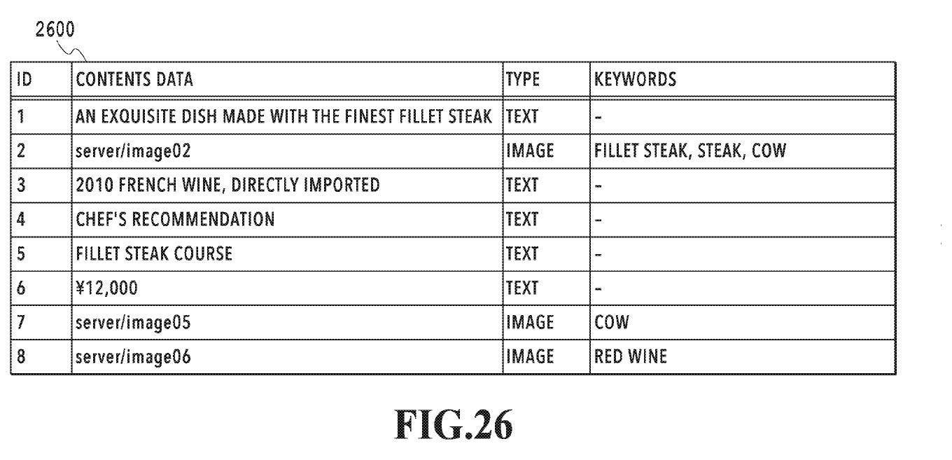

In S2404, the CPU 201 (the replacement unit 2140) of the server 101 replaces the first image contents with the second image contents. At this time, the replacement unit 2140 generates a data table 2600 after replacement (FIG. 26) corresponding to the layout data after replacement. At this stage, only the first image contents designated by the user are replaced, and the other image contents and text contents are in the same state as in the data table 2300 before replacement.

In S2405, the first keyword extraction unit 522 of the specifying unit 2120 extracts a word or phrase indicating the features of the first image contents as the first keyword KW1. As described above, the first keyword KW1 may be the caption of an image or may be text data obtained by character recognition from a character string included in the image. The first keyword extraction unit 522 stores the extracted first keyword KW1 in the item "keywords" of the data table 2300 before replacement, in association with the contents ID "2" indicating the first image contents.

In S2406, the second keyword extraction unit 532 of the obtaining unit 2130 extracts the second keyword KW2 from the second image contents. The method of extracting the second keyword KW2 is the same as the method of extracting the first keyword KW1. The second keyword extraction unit 532 stores the extracted second keyword KW2 in the item "keywords" of the data table after replacement, in association with the contents ID "2" indicating the second image contents.

In the processing up to this point, for example, the image contents 2202 of the layout data 2200 are designated by the user as the first image contents, and "Homard lobster, lobster, seafood" are extracted as the first keywords KW1. In addition, it is assumed that the image of a fillet steak is specified by the user as the image after replacement (the second image contents), and "fillet steak, steak, cow" are extracted as the second keywords KW2.

In S2407, the image contents obtaining unit 2121 of the specifying unit 2120 obtains image contents from among the contents included in the layout data 2200 to be processed. Here, all the image contents except the first image contents 2202 designated in S2401 are obtained from among the contents. In the example of FIG. 22, the image contents obtaining unit 2121 obtains the image contents 2207 and 2208 from the layout data 2200.

S2408 to S2418 are loop processing, and are executed by the specifying unit 2120, the obtaining unit 2130, and the replacement unit 2140 for all the image contents obtained in step S2407.

In S2409, the specifying unit 2120 first sets the image contents to be processed in the loop processing. The contents keyword extraction unit 2122 of the specifying unit 2120 extracts the contents keyword KW3 from the image contents to be processed. The processing of extracting the contents keyword KW3 from the image contents is the same as the processing by the first keyword extraction unit 522 and the second keyword extraction unit 532. That is, the contents keyword extraction unit 2122 extracts a word or phrase that indicates the features of the image contents to be processed as the contents keyword KW3. As described in FIG. 6, the contents keyword KW3 may be the caption of an image or may be a word or phrase or sentence obtained by character recognition from a character string included in the image. The contents keyword extraction unit 2122 requests the image recognition unit 422 or the image captioning unit 425 to generate a caption by using the image data of the image contents to be processed as an input image. As a response to this, the contents keyword extraction unit 2122 obtains one or more captions that are text data and sets the obtained caption(s) as the contents keyword(s) KW3. The contents keyword extraction unit 2122 stores the extracted contents keyword KW3 in the item "keywords" of the data table 2300 before replacement, in association with the contents ID indicating the image contents to be processed.

It should be noted that the contents keyword extraction unit 2122 may obtain information of the matching rate along with the caption (keyword), and extract the keyword based on the condition regarding the matching rate. In addition, the image data of the image contents may be processed to narrow down the target to be analyzed. For example, the contents keyword extraction unit 2122 sets the image of a representative object extracted from the image data of the image contents as an input image to the image captioning unit 425 and the image recognition unit 422. The representative object may be determined based on the size and display position of the object in the image contents. In addition, in a case where the image contents displayed in the layout data is a part of the image data, only the portion displayed in the layout data may be used as the input image.

The determination processing in S2410 and S2411 are the same as that in S1110 and S1111. In S2410, the determination unit 524 determines whether or not the contents keyword KW3 extracted in S2409 matches (partially matches or exactly matches) the first keyword KW1 obtained in S2405. In a case where it is determined to be a match (YES in S2410), the third contents specifying unit 525 specifies the image contents currently being the target of the loop processing as the third contents. Thereafter, the processing proceeds to S2412. In a case where it is determined that the contents keyword KW3 and the primary keyword KW1 are neither a partial match nor an exact match (NO in S2410), the processing proceeds to S2411.

In S2411, the determination unit 524 determines whether or not the contents keyword KW3 extracted in S2409 has an affinity with the first keyword KW1 extracted in S2405. In a case where it is determined that there is an affinity (YES in S2411), the third contents specifying unit 525 specifies the image contents currently being the target of the loop processing as the third contents, and the processing proceeds to S2416. In a case where it is determined that there is no affinity between the contents keyword KW3 and the first keyword KW1 (in a case where it is determined to be NO in S2411), the third contents specifying unit 525 does not specify the image contents currently being the target of the loop processing as the third contents and skips S2415 to S2417. Thereafter, the next image contents are set to the target to be processed, and the processing in S2409 to S2417 is repeated. The processing of determining whether or not there is an affinity is the same as that in the first embodiment.

In a case where the first keyword KW1 and the contents keyword KW3 match (a partial match or an exact match), S2412 to S2414 are executed by the obtaining unit 2130 on the image contents (the third contents) that are the source of the contents keyword KW3.

In S2412, the fourth contents obtaining unit 2131 determines whether the image content specified as the third contents is an image including text. In a case where it is determined that the third contents are image contents including text (YES in S2412), the processing proceeds to S2413. In a case where it is determined that the third contents do not include text (NO in S2412), the processing proceeds to S2414.

In S2413, the fourth contents obtaining unit 2131 obtains new image contents (the fourth contents) based on the image contents specified as the third contents and the second keyword KW2.

In S2414, the fourth contents obtaining unit 2131 obtains new image contents (the fourth contents) corresponding to the second keyword KW2.

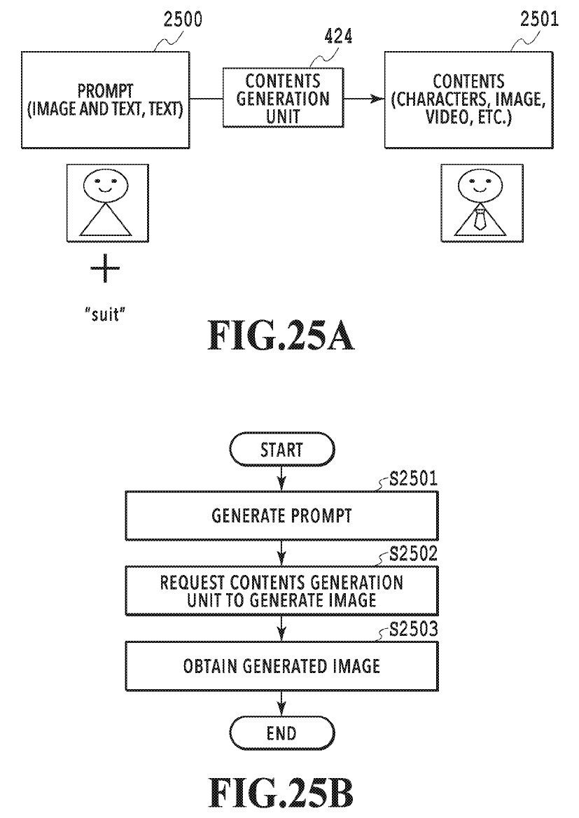

FIG. 25A is a diagram illustrating the concept of the contents generation processing in S2413 and S2414. The fourth contents obtaining unit 2131 requests the contents generation unit 424 to generate an image. As described above, the contents generation unit 424 is a generative AI, and includes an image generation model that generates image contents and a text generation model that generates text contents. As illustrated in FIG. 25A, in a case where a prompt 2500 including an image and text is input, the contents generation unit 424 generates and outputs contents 2501 such as characters, an image, and a video corresponding to the prompt 2500. The relationship between the input prompt 2500 and the output contents 2501 is obtained by the model having been trained using a large number of images and sentences. For example, in a case where an image of a person and a prompt including the text "Suit" are input to the contents generation unit 424, the contents generation unit 424 generates and outputs an image of a person wearing a suit. It should be noted that in contents generation using a generative AI, the same output is not always obtained from the same input, and different results are output each time processing is performed. The output can also be changed by changing an initial value (a random number or the like) that is set in image generation.

FIG. 25B is a flowchart illustrating the flow of the contents generation processing utilizing the generative AI illustrated in FIG. 25A.

In S2501, the fourth contents obtaining unit 2131 generates a prompt to be input to the contents generation unit 424. The prompt may include an image and text as described above or may only include text.

In S2502, the fourth contents obtaining unit 2131 requests the prompt generated in S2501 from the image generation AI (the contents generation unit 424). The contents generation unit 424 generates an image based on the input prompt, and outputs the generated image to the fourth contents obtaining unit 2131.

In S2503, the fourth contents obtaining unit 2131 obtains the image that is output from the contents generation unit 424.

In S2413, the fourth contents obtaining unit 2131 generates a prompt including the image contents specified as the third contents and the second keyword KW2 extracted from the second image contents and requests the contents generation unit 424 to generate an image. The prompt is made to include a sentence that the text included in the image contents will be changed to the second keyword KW2. For example, in a case where the third contents include the text "seasonal vegetables," the contents generation unit 424 generates an image in which all or a part of the text "seasonal vegetables" is replaced with the second keyword KW2.

In S2414, the fourth contents obtaining unit 2131 generates a prompt to generate a new image related to the second keyword KW2, which corresponds to the relationship between the first keyword KW1 and the contents keyword KW3. The fourth contents obtaining unit 2131 inputs the prompt to the contents generation unit 424 to request the generation of an image.

The image contents 2207 included in the layout data illustrated in FIG. 22 is an image of a lobster, and "lobster" and the like are extracted as contents keywords KW3. Therefore, in the determination in S2410, since there is a partial match with the first keyword KW1, which is “Homard lobster,” "lobster" is specified as the third contents. Since the image contents 2207 do not include text, it is determined to be "NO" in S2412, and the processing proceeds to S2414.

In S2414, the fourth contents obtaining unit 2131 obtains a new image related to the second keywords KW2 (fillet steak, steak, cow), which corresponds to the relationship between the first image contents (Homard lobster dish) and the third contents (living lobster). The fourth contents obtaining unit 2131 first generates a prompt and inputs the generated prompt to the contents generation unit 424. The prompt may include only text (the first keyword KW1, the contents keyword KW3, and the second keyword KW2) without an image, or may include image contents corresponding to each keyword. As a result, it is assumed that the contents generation unit 424 generates, as a new image related to the second keyword KW2 (fillet steak, steak, cow), for example, an image of a cow that is the living creature that serves as the raw material for fillet steak. The fourth contents obtaining unit 2131 obtains the file path (server/image05) of the generated image, associates the file path with the contents ID "7" of the image contents 2207, and saves the file path in the data table 2600 after replacement. The fourth contents obtaining unit 2131 inputs the obtained image contents to the replacement unit 2140 as the fourth contents. Thereafter, the processing proceeds to S2415.

In S2415, the replacement unit 2140 replaces the image contents to be processed (the image contents specified as the third contents) with the newly obtained fourth contents. Thereafter, the processing returns to S2409, and the processing in S2409 to S2415 is performed on the next unprocessed image contents among the image contents obtained in S2407.

Next, S2416 will be described. Step S2416 is executed in a case where it is determined in the determination processing in S2410 to S2411 that the contents keyword KW3 extracted in S2409 has an affinity with the first keyword KW1 obtained in step S2405.

The obtaining unit 2130 obtains the first keyword KW1 extracted in S2405, the second keyword KW2 extracted in S2406, and the contents keyword KW3 determined to have an affinity in S2411, and inputs them to the fourth keyword obtaining unit 534. The method of obtaining the contents keyword KW3 having an affinity is the same as that in S1111 in the first embodiment.

The fourth keyword obtaining unit 534 obtains the fourth keyword KW4 related to the second keyword KW2, which corresponds to the relationship between the first keyword KW1 and the contents keyword KW3 that has an affinity with the first keyword KW1. In the present embodiment, the fourth keyword obtaining unit 534 obtains the fourth keyword KW4 related to the second keyword KW2, which corresponds to the relationship between the first keyword KW1 and the contents keyword KW3, by asking the natural language processing unit 421 a question.

The fourth contents obtaining unit 2131 generates a prompt to generate an image corresponding to the fourth keyword KW4 and requests the contents generation unit 424 to generate the image.

It is assumed that the image contents 2208 in FIG. 22 is an image of white wine, and "white wine" has been extracted as the contents keyword KW3. In the determination of whether or not there is a match with the first keyword KW1 in S2410, it is determined to be "NO", and the processing proceeds to S2411. In S2411, the determination unit 524 determines whether or not there is an affinity between the contents keyword KW3"white wine" and the first keywords KW1 (Homard lobster, lobster, seafood). As a result, it is determined that there is an affinity, and the processing proceeds to S2416. The processing in S2416 is the same as the processing in S1501 to S1508 in the first embodiment and obtains the fourth keyword from the natural language processing unit 421. The fourth keyword obtaining unit 534 obtains "red wine" as the fourth keyword KW4 corresponding to the relationship between the first keyword KW1 (lobster) and the contents keyword KW3 (white wine). In S2417, the fourth contents obtaining unit 2131 requests the contents generation unit 424 to generate an image corresponding to the fourth keyword KW4 obtained in S2416. The fourth contents obtaining unit 2131 obtains an image of red wine generated by the contents generation unit 424, and saves its file path (server/image06) in the data table 2600 after replacement in association with the contents ID "8" of the third contents. The fourth contents obtaining unit 2131 inputs the obtained image contents to the replacement unit 2140 as the fourth contents. Thereafter, the processing proceeds to S2415.

Once the loop processing in S2408 to S2418 ends for all the image contents obtained in S2407, the flowcharts of FIGS. 24A and 24B end.

### Data Table after Replacement

FIG. 26 illustrates a data table 2600 after replacement corresponding to the layout data after replacement at the stage when the contents replacement processing illustrated in FIGS. 11A and 11B (the first embodiment) and FIGS. 24A and 24B (the second embodiment) ends. The data table 2600 after replacement is saved in the layout data DB 412.

### Layout Data after Replacement

FIG. 27 is a diagram illustrating a display example of layout data 2700 after replacement corresponding to the data table 2600 after replacement illustrated in FIG. 26.

As illustrated in FIG. 26, the data table 2600 after replacement stores the contents IDs for identifying each of the contents included in the layout data 2700 after replacement, contents data, type, and keywords. The contents data with the contents ID "1" corresponds to the text contents 2701 in FIG. 27, and the type is "text." The contents data with the contents ID "2" corresponds to the image contents 2702 in FIG. 27, and the file path "server/image02" is stored in the contents data. The type is "image." The contents data with the contents ID "3" corresponds to the text contents 2203 in FIG. 27, and the type is "text." The contents data with the contents ID "4" corresponds to the text contents 2204 in FIG. 27, and the type is "text." The contents data with the contents ID "5" corresponds to the text contents 2705 in FIG. 27, and the type is "text." The contents data with the contents ID "6" corresponds to the text contents 2206 in FIG. 27, and the type is "text." The contents data with a contents ID of "7" corresponds to the image contents 2707 in FIG. 27, and the file path "server/image05" is stored in the contents data. The type is "image." The contents data with a contents ID of "8" corresponds to the image contents 2708 in FIG. 27, and the file path "server/image06" is stored in the contents data. The type is "image." It should be noted that in FIG. 27, the same contents as those in the layout data 2200 before replacement illustrated in FIG. 22 are denoted by the same numerals as those illustrated in FIG. 22.

The layout data 2200 before replacement illustrated in FIG. 22 and the layout data 2700 after replacement illustrated in FIG. 27 will be compared. The first image contents 2202 (the image of an Homard lobster dish) before replacement has been replaced with the second image contents 2702 (the image of a steak). This replacement processing is performed in S2401 to S2404 by the user's designation operation and the replacement unit 2140. As the third contents related to the first image contents 2202, the image contents 2207 and 2208 in FIG. 22 are specified. This specifying processing is performed by the specifying unit 2120 in S2407 to S2411. In addition, the text contents 901 and 905 in FIG. 22 are also specified in S1107 to S1111.

The image contents 2207 in FIG. 22 is replaced with the fourth contents 2707 (an image of a cow) as illustrated in FIG. 27. The fourth contents 2707 is the image contents generated in S2414. The second image contents (the image of a fillet steak) is replaced with the fourth contents 2707 (the image of a cow), so as to correspond to the relationship between the first image contents 2202 (the image of a lobster dish) and the third contents (the image of a lobster).

The image contents 2208 in FIG. 22 are the third contents determined to have an affinity with the first image contents 2202 (the image of a lobster dish) and is replaced with the fourth contents 2708 (the image of white wine) as illustrated in FIG. 27. The fourth contents 2708 are the image contents generated in S2416 to S2417. The fourth contents 2708 (the image of red wine) having an affinity with the second image contents (the image of steak) are generated and replaced, so as to correspond to the relationship between the first image contents 2202 (the image of a lobster dish) and the third contents (the image of white wine).

The replacement processing of these image contents is executed by the replacement unit 2140. It should be noted that the text contents 2701 and 2705 have been replaced by the processing in the first embodiment, so as to include the text contents (fillet steak) corresponding to the second image contents (the image of fillet steak) after replacement. The text contents 2203, 2204, and 2206 in FIG. 22 are determined not to be related to the first image contents 2202, are not replaced, and are the same as those in the layout data 2200 before replacement.

As described above, the layout editing application 410 illustrated in the second embodiment includes the contents replacement processing unit 442 and executes the contents replacement processing in a case where the user designates the image contents included in the layout data to replace the image contents with another image contents. The contents replacement processing unit 442 specifies the image contents (the third contents) directly related to the image contents before replacement from among the contents included in the layout data. In addition, the image contents are replaced with the image contents (the fourth contents) corresponding to the image contents after replacement. Furthermore, the contents replacement processing unit 442 specifies the image contents (the third contents) having an affinity with the image contents before replacement. In addition, new image contents (the fourth contents) related to the image contents after replacement are generated, and the third contents are replaced with the fourth contents. Accordingly, in conjunction with the replacement of a part of the contents in the layout data, the other related contents are also changed to appropriate contents. Thus, the workload of editing the layout data is reduced, and the usability is improved.

### Modification 3

In the second embodiment, although the example has been described in which the first contents and the second contents designated by the user are image contents, the first contents and the second contents may be text contents. That is, in a case where replacement of text contents in layout data is executed according to an operation by the user, the server 101 specifies other related image contents (the third contents) from among the contents included in the layout data. Then, the image contents are replaced with the image contents (the fourth contents) corresponding to the text contents (the second contents) after replacement.

In Modification 3, the system configuration of the information processing system 100, and the hardware and functional configurations of the server 101 and the client terminal 102 are the same as those in the second embodiment. However, the processing in the first keyword extraction unit and the second keyword extraction unit is changed to processing of extracting a keyword from text contents.

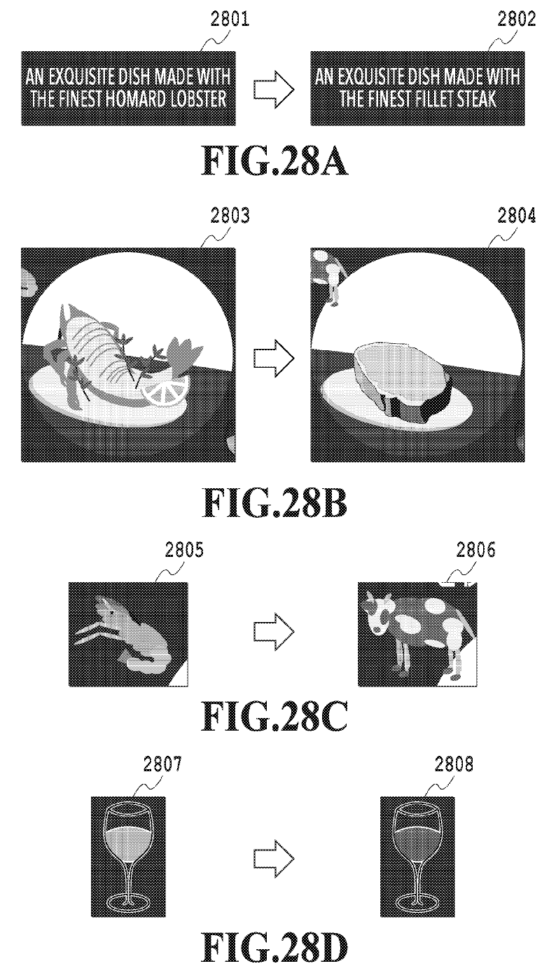

FIGS. 28A to 28D are diagrams illustrating replacement of image contents along with replacement of text contents according to an operation by the user. It is assumed that the diagrams on the left side of FIGS. 28A, 28B, 28C, and 28D, illustrate the contents included in the layout data before replacement, and the diagrams on the right side illustrate the contents included in the layout data after replacement.

As illustrated in FIG. 28A, it is assumed that text contents 2801, "An exquisite dish made with the finest Homard lobster," are changed to text contents 2802, "An exquisite dish made with the finest fillet steak," according to an operation by the user. The text contents 2801 are the first contents before replacement, and the text contents 2802 are the second contents after replacement.

In this case, the first keyword extraction unit 522 extracts the first keyword KW1 (“Homard lobster”) from the text contents 2801, "An exquisite dish made with the finest Homard lobster." In addition, the second keyword extraction unit 532 extracts the second keyword KW2 (“fillet steak”) from the text contents 2802 after replacement, "An exquisite dish made with the finest fillet steak."

The processing of specifying the third contents by the specifying unit 2120 is the same as that in the second embodiment. Among the image contents included in the layout data before replacement, the image contents that include a keyword that matches the first keyword KW1 (“Homard lobster”), or that has an affinity with the first keyword KW1 are specified as the third contents. Image contents 2803 (the image of a lobster dish) in FIG. 28B, image contents 2805 (the image of a lobster) in FIG. 28C, and image contents 2807 (the image of white wine) in FIG. 28D are specified as the third contents.

The process of obtaining the fourth contents by the obtaining unit 2130 is also the same as that in the second embodiment. The fourth contents obtaining unit 2131 obtains the fourth contents related to the second contents, which correspond to the relationship between the first contents and the third contents. For example, as illustrated in FIG. 28B, image contents 2804 (the image of a fillet steak dish) are generated as the image contents corresponding to the image contents 2803 (the image of a lobster dish). In addition, as illustrated in FIG. 28C, image contents 2806 (the image of a cow) is generated as the image contents corresponding to the image contents 2805 (the image of a lobster). In addition, as illustrated in FIG. 28D, image contents 2808 (the image of red wine) is generated as the image contents corresponding to the image contents 2807 (the image of white wine).

The replacement processing by the replacement unit 2140 is also the same as that in the second embodiment. The replacement unit 2140 replaces the text contents designated by the user with another text contents. In addition, among the contents included in the layout data, the image contents related to the first contents are replaced with the image contents related to the second contents.

As described above, according to Modification 3, even in a case where the user designates text contents included in the layout data to replace the text contents with another text contents, the contents replacement processing is executed in the same manner as in the second embodiment. That is, the contents replacement processing unit 2100 specifies the image contents (the third contents) directly related to the text contents before replacement from among the contents included in the layout data. In addition, the image contents are replaced with image contents (the fourth contents) corresponding to the text contents after replacement being generated. Furthermore, the contents replacement processing unit 442 specifies the image contents (the third contents) having an affinity with the text contents before replacement. In addition, new image contents (the fourth contents) related to the text contents after replacement are generated, and the third contents are replaced with the fourth contents. Accordingly, in conjunction with the replacement of a part of the contents in the layout data, the other related image contents are also changed to appropriate contents. Thus, the workload of editing the layout data is reduced, and the usability is improved.

It should be noted that also in the second embodiment and Modification 3, as illustrated in Modification 1, in a case where there are a plurality of generated fourth contents, a selection of the fourth contents may be accepted from the user. In this case, the selection UI 2000 may be displayed on the client terminal 102. In addition, the replacement of associated text contents in the layout data may also be simultaneously performed.

In a case where these embodiments are put into other words, in the information processing apparatus of the present disclosure, the contents replacement processing unit replaces contents before replacement included in layout data with contents after replacement, in response to an instruction by the user (a first replacement unit). In that case, the contents replacement processing unit replaces the contents related to the contents before replacement among the contents included in the layout data with the contents related to the contents after replacement (a second replacement unit). The contents replaced by the second replacement unit will be different between a case where the first replacement unit replaces the contents before replacement with contents A that are the contents after replacement, and a case where the first replacement unit replaces the contents before replacement with contents B that are the contents after replacement different from the first contents.

Although the preferred embodiments of the present disclosure have been described above with reference to the accompanying drawings, the present disclosure is not limited to such examples. For example, the layout data, the UI screens, the prompts, and the processing procedures are examples, and are not limited to the illustrated examples. It is clear that a person skilled in the art can conceive various modifications or alterations within the scope of the disclosed technical ideas, and it is understood that these also naturally belong to the technical scope of the present disclosure.

With the present disclosure, the usability in editing work of layout data can be improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020848, filed February 12, 2025, which is hereby incorporated by reference herein in its entirety.

What is claimed is:

1. An information processing apparatus comprising:
one or more processors; and
one or more memories storing instructions to cause the one or more processors to function as:
an accepting unit configured to accept a designation of first contents before replacement from among a plurality of contents included in layout data, and a designation of second contents to be arranged in the layout data instead of the first contents;
a specifying unit configured to specify, from among the plurality of contents included in the layout data, third contents related to the first contents;
an obtaining unit configured to obtain fourth contents related to the second contents; and
a replacement unit configured to replace the first contents with the second contents and the third contents with the fourth contents in the layout data,
wherein the specifying unit
extracts a word or phrase indicating features of the first contents as a first keyword,
extracts, as a contents keyword, for each of the plurality of contents other than the first contents, a word or phrase indicating features of the each of the plurality of contents other than the first contents, and
specifies, from among the plurality of contents other than the first contents, contents having the contents keyword related to the first keyword as the third contents.

2. The information processing apparatus according to claim 1, wherein the third contents are text contents or image contents having the contents keyword that partially or exactly matches the first keyword.

3. The information processing apparatus according to claim 1, wherein the third contents are text contents or image contents having the contents keyword that has an affinity with the first keyword.

4. The information processing apparatus according to claim 3, wherein the specifying unit queries a natural language processing model whether or not there is an affinity between the first keyword and the contents keyword.

5. The information processing apparatus according to claim 1, wherein in a case where the first contents are image contents, or for image contents from among the plurality of contents, the specifying unit uses a caption of the image contents as the first keyword or the contents keyword.

6. The information processing apparatus according to claim 1, wherein in a case where the first contents are image contents, or for image contents from among the plurality of contents, the specifying unit uses a character string detected from the image contents as the first keyword or the contents keyword.

7. The information processing apparatus according to claim 1, wherein in a case where the first contents are text contents, or for text contents from among the plurality of contents, the specifying unit uses the entire text contents or a word or phrase extracted from the text contents as the first keyword or the contents keyword.

8. The information processing apparatus according to claim 1, wherein the obtaining unit obtains the fourth contents from a natural language processing model.

9. The information processing apparatus according to claim 8, wherein the obtaining unit generates a prompt for obtaining the fourth contents from the natural language processing model by using the first keyword extracted from the first contents, the contents keyword extracted from the third contents, and a second keyword extracted from the second contents.

10. The information processing apparatus according to claim 1, wherein the obtaining unit obtains the fourth contents from an image generation model.

11. The information processing apparatus according to claim 1, wherein the obtaining unit generates the fourth contents by replacing the contents keyword extracted from the third contents with a second keyword extracted from the second contents.

12. The information processing apparatus according to claim 11, wherein in a case where the contents keyword extracted from the third contents includes a plurality of keywords related to the first keyword extracted from the first contents, the obtaining unit obtains the fourth contents by selecting from among the plurality of keywords a keyword with a large number of characters, and replacing the selected keyword with the second keyword extracted from the second contents.

13. The information processing apparatus according to claim 12, wherein a character string included in the second contents that has a number of characters close to a number of characters of the first keyword is set as the second keyword.

14. The information processing apparatus according to claim 1, wherein the obtaining unit further includes a selecting unit configured to obtain a plurality of fourth contents and cause a user to select contents to replace the third contents from among the plurality of fourth contents.

15. The information processing apparatus according to claim 1, wherein the first contents and the second contents are image contents, and the third contents and the fourth contents are text contents.

16. The information processing apparatus according to claim 1, wherein the first contents and the second contents are text contents, and the third contents and the fourth contents are text contents.

17. The information processing apparatus according to claim 1, wherein the first contents and the second contents are image contents, and the third contents and the fourth contents are image contents.

18. The information processing apparatus according to claim 1, wherein the first contents and the second contents are text contents, and the third contents and the fourth contents are image contents.

19. An information processing method to be executed by an information processing apparatus, the information processing method comprising:
accepting a designation of first contents before replacement from among a plurality of contents included in layout data, and a designation of second contents to be arranged in the layout data instead of the first contents;
specifying, from among the plurality of contents included in the layout data, third contents related to the first contents;
obtaining fourth contents related to the second contents; and
replacing the first contents with the second contents and the third contents with the fourth contents in the layout data,
wherein in specifying the third contents,
a word or phrase indicating features of the first contents is extracted as a first keyword,
a word or phrase indicating features of each of the plurality of contents other than the first contents is extracted as a contents keyword for each of the plurality of contents other than the first contents, and
from among the plurality of contents other than the first contents, contents having the contents keyword related to the first keyword are specified as the third contents.

20. A non-transitory computer readable storage medium storing a program which causes a computer to execute an information processing method,
the information processing method comprising:
accepting a designation of first contents before replacement from among a plurality of contents included in layout data, and a designation of second contents to be arranged in the layout data instead of the first contents;
specifying, from among the plurality of contents included in the layout data, third contents related to the first contents;
obtaining fourth contents related to the second contents; and
replacing the first contents with the second contents and the third contents with the fourth contents in the layout data,
wherein in specifying the third contents,
a word or phrase indicating features of the first contents is extracted as a first keyword,
a word or phrase indicating features of each of the plurality of contents other than the first contents is extracted as a contents keyword for each of the plurality of contents other than the first contents, and
from among the plurality of contents other than the first contents, contents having the contents keyword related to the first keyword are specified as the third contents.
